(19) United States
(12) Patent Application Publication
(10) Pub. No.: US 2026/0230541 A1
(43) Pub. Date: Aug. 6, 2026

(54) Sequence Transmission Method and Apparatus

(71) Applicant: HUAWEI TECHNOLOGIES CO., LTD., Shenzhen (CN)

(72) Inventors: Ke Liu, Hangzhou (CN); Jiajie Tong, Hangzhou (CN); Huazi Zhang, Hangzhou (CN); Xianbin Wang, Hangzhou (CN); Kangjian Qin, Hangzhou (CN); Jun Wang, Hangzhou (CN)

(73) Assignee: HUAWEI TECHNOLOGIES CO., LTD., Shenzhen (CN)

(21) Appl. No.: 19/631,285

(22) Filed: Mar. 27, 2026

Related U.S. Application Data
(63) Continuation of application No. PCT/CN2023/122356, filed on Sep. 27, 2023.

(51) Int. Cl. H04L 69/04

(52) U.S. Cl. CPC H04L 69/04

(57) ABSTRACT

A sequence transmission method includes that a sending device determines, based on an information bit sequence, an information column quantity set associated with a base graph and a lifting size set associated with the base graph, where the base graph corresponds to the information bit sequence; determines a target information column quantity and a target lifting size based on the information column quantity set and the lifting size set; and encodes the information bit sequence based on the target information column quantity and the target lifting size, to obtain an encoded bit sequence. The target information column quantity and the target lifting size are determined by comparing X first metrics, and an x^{th} first metric in the X first metrics is determined based on a length of the information bit sequence.

### CROSS-REFERENCE TO RELATED APPLICATIONS

This is a continuation of International Patent Application No. PCT/CN2023/122356 filed on Sep. 27, 2023, the disclosure of which is hereby incorporated by reference in its entirety.

### TECHNICAL FIELD

This application relates to the field of communication technologies, and in particular, to a sequence transmission method and an apparatus.

### BACKGROUND

A low-density parity-check (LDPC) code is a channel coding scheme, and effectiveness of LDPC code encoding can be improved by using a rate matching method. A sending device may determine a quantity of information columns of a base graph (BG) based on a length of an information bit sequence, determine a lifting size (LS) based on the quantity of information columns of the base graph, and determine a quantity of shortened bits based on the length of the information bit sequence, the information column quantity, and the lifting size, to implement rate matching.

However, because the determining of the information column quantity is associated only with the length of the information bit sequence, as the length of the information bit sequence continuously increases, the information column quantity determined based on the length may also continuously increase. Consequently, the determined quantity of shortened bits may increase exponentially, degree distribution of the base graph is damaged, integrity of the base graph is impaired, and decoding performance is degraded.

Therefore, how to determine the information column quantity and the lifting size to protect degree distribution of the base graph and integrity of the base graph and improve decoding performance becomes an urgent problem to be resolved.

### SUMMARY

Embodiments of this application provide a sequence transmission method and an apparatus, to determine an information column quantity and a lifting size, protect degree distribution of a base graph and integrity of the base graph, and improve decoding performance.

The degree distribution of the base graph may affect column weight distribution of a parity-check matrix. A design objective of an LDPC code is to optimize a decoding threshold, and the column weight distribution is one of main factors that affect the decoding threshold. Therefore, in a rate matching process, particular attention is paid to the degree distribution of the base graph. To be specific, a sending device may determine the base graph based on a length of an information bit sequence, and then determine the column weight distribution of the parity-check matrix, so that the decoding threshold can be optimized based on the column weight distribution.

In the rate matching process, the sending device may determine a quantity of shortened bits based on the information column quantity, the lifting size, and the length of the information bit sequence. Due to presence of shortened bits, some information columns of the base graph may be removed. Consequently, integrity of the base graph may be impaired, and degree distribution of the base graph may change, resulting in a suboptimal decoding threshold. Therefore, when the sending device determines the information column quantity and the lifting size, the integrity of the base graph and degree distribution of the base graph can be ensured as much as possible, so that the column weight distribution of the parity-check matrix is ensured, thereby improving decoding performance.

According to a first aspect, a sequence transmission method is provided. The method may be performed by a sending device. Unless otherwise specified, the “sending device” in this application may be the sending device itself, or may be a component (for example, a processor, a chip, or a chip system) in the sending device, or may be a logical module or software that can implement all or some functions of the sending device. The method includes that a sending device determines, based on an information bit sequence, an information column quantity set associated with a base graph corresponding to the information bit sequence and a lifting size set associated with the base graph; determines a target information column quantity and a target lifting size based on the information column quantity set and the lifting size set; and encodes the information bit sequence based on the target information column quantity and the target lifting size to obtain an encoded bit sequence. The target information column quantity and the target lifting size are determined by comparing X first metrics, an x^{th} first metric in the X first metrics is determined based on a length of the information bit sequence, an i^{th} information column quantity in the information column quantity set, and a j^{th} lifting size in the lifting size set, and the i^{th} information column quantity corresponds to the j^{th} lifting size; X is greater than or equal to 2; and x=1, 2, . . . , X.

Based on the foregoing solution, unlike a sending device that determines a target information column quantity based on a length of an information bit sequence and then determines a target lifting size based on the target information column quantity, the sending device in this application may determine the target information column quantity and the target lifting size by comparing the X first metrics. On one hand, more feasible solutions may be provided for determining the target information column quantity and the target lifting size. On the other hand, a difference between the length of the information bit sequence and a product of the target information column quantity and the target lifting size may not increase as the length of the bit sequence increases, and the difference may be relatively small or remain within a specific range. In this way, degree distribution of the base graph and integrity of the base graph can be protected, and decoding performance can be improved.

According to a second aspect, a sequence transmission method is provided. The method may be performed by a receiving device. Unless otherwise specified, the “receiving device” in this application may be the receiving device itself, or may be a component (for example, a processor, a chip, or a chip system) in the receiving device, or may be a logical module or software that can implement all or some functions of the receiving device. The method includes that a receiving device obtains to-be-decoded information from a sending device; and decodes the to-be-decoded information based on a target information column quantity and a target lifting size, to obtain a decoded information bit sequence. The target information column quantity and the target lifting size are determined by comparing X first metrics, an x^{th} first metric in the X first metrics is determined based on a length of the information bit sequence, an i^{th} information column quantity in an information column quantity set, and a j^{th} lifting size in a lifting size set, and the i^{th} information column quantity corresponds to the j^{th} lifting size; X is greater than or equal to 2; x=1, 2, . . . , X; and the information column quantity set and the lifting size set are associated with a base graph corresponding to the information bit sequence.

Based on the foregoing solution, after receiving the to-be-decoded information, the receiving device needs to decode the to-be-decoded information based on the target information column quantity and the target lifting size. For determining a target information column quantity and a target lifting size, unlike a receiving device that determines a target information column quantity based on a length of an information bit sequence and then determines a target lifting size based on the target information column quantity, the receiving device in this application may determine the target information column quantity and the target lifting size by comparing the X first metrics. On one hand, more feasible solutions may be provided for determining the target information column quantity and the target lifting size. On the other hand, the difference between the length of the information bit sequence and the product of the target information column quantity and the target lifting size may not increase as the length of the bit sequence increases, and the difference may be relatively small or remain within a specific range. In this way, degree distribution of the base graph and integrity of the base graph can be protected, and decoding performance can be improved.

With reference to the first aspect and the second aspect, in a possible implementation, the x^{th} first metric is a difference between a first product and the length of the information bit sequence; or the x^{th} first metric is a ratio of a first difference to the j^{th} lifting size, where the first product is a product of the i^{th} information column quantity and the j^{th} lifting size, and the first difference is the difference between the first product and the length of the information bit sequence.

Based on this possible implementation, the x^{th} first metric may be determined based on the foregoing two methods, and a plurality of feasible solutions are provided for determining the x^{th} first metric.

With reference to the first aspect and the second aspect, in a possible implementation, the j^{th} lifting size is a smallest lifting size that is in the lifting size set and that supports the i^{th} information column quantity in meeting a first condition; or the j^{th} lifting size is a smallest lifting size that is in the lifting size set and whose value is equal to

$${n}^{⌈ {log}_{n} ( \frac{K}{{K}_{i} q} ) ⌉} q ;$$

or the j^{th} lifting size is a smallest lifting size that is in the lifting size set and whose value is equal to

$$⌈ \frac{K}{{K}_{i} q} ⌉ q ,$$

where n is an integer greater than or equal to 2, and K is the length of the information bit sequence; Kᵢ is the i^{th} information column quantity in the information column quantity set, and q is a positive integer; and the first condition is that a product of the i^{th} information column quantity and the lifting size in the lifting size set is greater than or equal to the length of the information bit sequence.

Based on this possible implementation, the lifting size corresponding to the i^{th} information column quantity may be determined by using the foregoing three methods, so that the lifting size corresponding to each information column quantity may be determined. In addition, determining, based on

$${n}^{⌈ {log}_{n} ( \frac{K}{{K}_{i} q} ) ⌉} q or ⌈ \frac{K}{{K}_{i} q} ⌉ q ,$$

the lifting size corresponding to the i^{th} information column quantity has lower computational complexity than determining the lifting size corresponding to the i^{th} information column quantity by using the first method, thereby improving working efficiency.

With reference to the first aspect and the second aspect, in a possible implementation, when q is a prime number, the j^{th} lifting size is the smallest lifting size that is in the lifting size set and whose value is equal to

$$⌈ \frac{K}{{K}_{i} q} ⌉ q .$$

Based on this possible implementation, when q is a prime number, occurrence of a short cycle may be avoided from three aspects. To be specific, in a first aspect, a girth of a Tanner graph is increased as much as possible (the girth is defined as a length of a shortest cycle); in a second aspect, a quantity of short cycles is reduced as much as possible when the girth cannot be increased; and in a third aspect, when the quantity of short cycles cannot be reduced, overlapping between short cycles or presence of a large quantity of common edges between short cycles are avoided.

With reference to the first aspect and the second aspect, in a possible implementation, the i^{th} information column quantity is a smallest information column quantity that is in the information column quantity set and that supports the j^{th} lifting size in meeting a second condition; or the i^{th} information column quantity is an information column quantity that is in the information column quantity set and whose value is equal to

$$\frac{K}{{Z}_{j}} ,$$

where the second condition is that a product of the j^{th} lifting size and the information column quantity in the information column quantity set is greater than or equal to the length of the information bit sequence.

Based on this possible implementation, the information column quantity corresponding to the j^{th} lifting size may be determined by using the foregoing two methods, so that the information column quantity corresponding to each lifting size may be determined. In addition, determining, based on

$$\frac{K}{{Z}_{j}} ,$$

the information column quantity corresponding to the j^{th} lifting size has lower computational complexity than determining the information column quantity corresponding to the j^{th} lifting size by using the first method, thereby improving working efficiency.

With reference to the first aspect and the second aspect, in a possible implementation, the information column quantity set includes I information column quantities; and the lifting size set includes J lifting sizes, where 1≤i≤I, and 1≤j≤J.

Based on this possible implementation, a quantity of information column quantities in the information column quantity set may be determined, and a quantity of lifting sizes in the lifting size set may be determined.

With reference to the first aspect and the second aspect, in a possible implementation, the target information column quantity and the target lifting size are determined based on a smallest value of the X first metrics; or Y first metrics are determined based on the X first metrics, and the target information column quantity and the target lifting size are determined based on the Y first metrics, where a y^{th} first metric in the Y first metrics is less than or equal to a first threshold corresponding to the y^{th} first metric, Y is greater than or equal to 1, and y=1, 2, . . . , Y.

Based on this possible implementation, the target information column quantity and the target lifting size are determined based on the smallest value, so that the difference between the length of the information bit sequence and the product of the target information column quantity and the target lifting size can be minimized. In this way, degree distribution of the base graph and integrity of the base graph can be protected. Alternatively, the target information column quantity and the target lifting size are determined based on the Y first metrics, so that more feasible solutions can be provided for determining the target information column quantity and the target lifting size, and the corresponding target information column quantity and the target lifting size can be determined based on an actual communication status, thereby improving flexibility in determining the target information column quantity and the target lifting size. In this way, degree distribution of the base graph and integrity of the base graph can be protected for different communication requirements, and decoding performance can be improved.

With reference to the first aspect and the second aspect, in a possible implementation, a first threshold corresponding to the x^{th} first metric is determined based on a lifting size corresponding to the x^{th} first metric.

Based on this possible implementation, a feasible method is provided for determining the first threshold corresponding to the first metric. The target information column quantity and the target lifting size are determined by using the first metric that is less than the first threshold. In this way, degree distribution of the base graph and integrity of the base graph can be protected, and decoding performance can be improved.

With reference to the first aspect and the second aspect, in a possible implementation, the first threshold corresponding to the x^{th} first metric is any one of the following: Zc, 2Zc, 3/2Zc, ½Zc, ⅓Zc, or ¼Zc; or the first threshold corresponding to the x^{th} first metric is any one of the following: 1, 2, 3/2, ½, ⅓, or ¼, where Zc is the lifting size corresponding to the x^{th} first metric.

Based on this possible implementation, optional values of the first threshold corresponding to the first metric are proposed, so that more feasible solutions are provided for determining the first threshold corresponding to the first metric, and the first threshold corresponding to the first metric may be determined based on an actual communication status, thereby improving working efficiency and improving flexibility in determining the first threshold.

With reference to the first aspect and the second aspect, in a possible implementation, when there are at least two smallest values, a largest or smallest one of at least two information column quantities corresponding to the at least two smallest values is determined as the target information column quantity, and a lifting size corresponding to the target information column quantity is determined as the target lifting size; or when there are at least two smallest values, a largest or smallest one of at least two lifting sizes corresponding to the at least two smallest values is determined as the target lifting size, and an information column quantity corresponding to the target lifting size is determined as the target information column quantity; or when there are at least two smallest values, the target information column quantity is determined, based on first indication information, from at least two information column quantities corresponding to the at least two smallest values, and a lifting size corresponding to the target information column quantity is determined as the target lifting size; or when there are at least two smallest values, the target lifting size is determined, based on first metric information, from at least two lifting sizes corresponding to the at least two smallest values, and an information column quantity corresponding to the target lifting size is determined as the target information column quantity, where the first indication information indicates a communication scenario.

Based on this possible implementation, when there are at least two smallest values, the target information column quantity and the target lifting size may be determined according to the foregoing several methods, and the target information column quantity and the target lifting size may be determined based on different communication requirements, so that the target information column quantity and the target lifting size can be determined more flexibly, thereby providing a plurality of feasible solutions for determining the target information column quantity and the target lifting size. In this way, degree distribution of the base graph and integrity of the base graph can be protected for different communication requirements, and decoding performance can be improved.

With reference to the first aspect and the second aspect, in a possible implementation, when Y is greater than 1, a largest or smallest one of Y information column quantities corresponding to the Y first metrics is determined as the target information column quantity, and a lifting size corresponding to the target information column quantity is determined as the target lifting size; or when Y is greater than 1, a largest or smallest lifting size of Y information column quantities corresponding to the Y first metrics is determined as the target lifting size, and an information column quantity corresponding to the target lifting size is determined as the target information column quantity; or when Y is greater than 1, the target information column quantity is determined, based on first indication information, from Y information column quantities corresponding to the Y first metrics, and a lifting size corresponding to the target information column quantity is determined as the target lifting size; or when Y is greater than 1, the target lifting size is determined, based on first indication information, from Y lifting sizes corresponding to the Y first metrics, and an information column quantity corresponding to the target lifting size is determined as the target information column quantity, where the first indication information indicates a communication scenario.

Based on this possible implementation, when Y is greater than 1, the target information column quantity and the target lifting size may be determined based on different communication requirements, so that the target information column quantity and the target lifting size can be determined more flexibly, thereby providing a plurality of feasible solutions for determining the target information column quantity and the target lifting size. In this way, degree distribution of the base graph and integrity of the base graph can be protected for different communication requirements, and decoding performance can be improved.

With reference to the first aspect and the second aspect, in a possible implementation, one or more candidate information column quantities and one or more candidate lifting sizes are determined, based on a code length of the information bit sequence, from the information column quantity set and the lifting size set that are associated with the base graph; or one or more candidate information column quantities and one or more candidate lifting sizes are determined, based on a code length and a code rate of the information bit sequence, from the information column quantity set and the lifting size set that are associated with the base graph; or one or more candidate information column quantities and one or more candidate lifting sizes are determined, based on the first indication information, from the information column quantity set and the lifting size set that are associated with the base graph.

Based on this possible implementation, one or more candidate information column quantities and one or more candidate lifting sizes are determined, so that a range for determining the target information column quantity and the target lifting size can be narrowed, thereby reducing computational complexity and improving working efficiency.

According to a third aspect, a sequence transmission method is provided. The method may be performed by a sending device. Unless otherwise specified, the “sending device” in this application may be the sending device itself, or may be a component (for example, a processor, a chip, or a chip system) in the sending device, or may be a logical module or software that can implement all or some functions of the sending device. The method includes that a sending device determines, based on first information, a code length interval corresponding to an information bit sequence, and determines an information column quantity corresponding to the code length interval as a target information column quantity; determines a target lifting size based on the target information column quantity and a length of the information bit sequence; and encodes the information bit sequence based on the target information column quantity and the target lifting size, to obtain an encoded bit sequence. The first information indicates an information column quantity corresponding to each of a plurality of code length intervals; the code length interval and the information column quantity corresponding to each code length interval are determined by comparing A first metrics; an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size; A is greater than or equal to 2; the information column quantity set and the lifting size set are associated with a base graph corresponding to the length value; a=1, 2, . . . , A; and the code length interval includes B length values, and 1≤b≤B.

Based on the foregoing solution, the sending device may explicitly determine, by determining the code length interval corresponding to the length of the information bit sequence, the information column quantity corresponding to the code length interval as the target information column quantity, thereby reducing computational complexity and improving working efficiency. The code length interval and the information column quantity corresponding to each code length interval are determined by comparing the A first metrics, so that a feasible solution is provided for determining the code length interval and the information column quantity corresponding to each code length interval. Therefore, a difference between the length value and a product of the target information column quantity and the target lifting size does not increase as the length of the bit sequence increases, and the difference may be relatively small or remain within a specific range. In this way, degree distribution of the base graph and integrity of the base graph can be protected, and decoding performance can be improved.

According to a fourth aspect, a sequence transmission method is provided. The method may be performed by a receiving device. Unless otherwise specified, the “receiving device” in this application may be the receiving device itself, or may be a component (for example, a processor, a chip, or a chip system) in the receiving device, or may be a logical module or software that can implement all or some functions of the receiving device. The method includes that a receiving device obtains to-be-decoded information from a sending device; determines a length of an information bit sequence corresponding to the to-be-decoded information; determines, based on first information, a code length interval corresponding to the length of the information bit sequence, and determines an information column quantity corresponding to the code length interval as a target information column quantity; determines a target lifting size based on the target information column quantity and a length of the information bit sequence; and decodes the to-be-decoded information based on the target information column quantity and the target lifting size, to obtain a decoded information bit sequence. The first information indicates an information column quantity corresponding to each of a plurality of code length intervals; the code length interval and the information column quantity corresponding to each code length interval are determined by comparing A first metrics; an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size; A is greater than or equal to 2; a=1, 2, . . . , A; the information column quantity set and the lifting size set are associated with a base graph corresponding to the length value; and the code length interval includes B length values, and 1≤b≤B.

Based on the foregoing solution, after receiving the to-be-decoded information, the receiving device may determine the length of the information bit sequence by using the to-be-decoded information, and then may explicitly determine, by determining the code length interval corresponding to the length of the information bit sequence, the information column quantity corresponding to the code length interval as the target information column quantity, thereby reducing computational complexity and improving decoding efficiency. The code length interval and the information column quantity corresponding to each code length interval are determined by comparing the A first metrics, so that a feasible solution is provided for determining the code length interval and the information column quantity corresponding to each code length interval. Therefore, a difference between the length value and a product of the target information column quantity and the target lifting size does not increase as the length of the bit sequence increases, and the difference may be relatively small or remain within a specific range. In this way, degree distribution of the base graph and integrity of the base graph can be protected, and decoding performance can be improved.

With reference to the third aspect and the fourth aspect, in a possible implementation, the a^{th} first metric is a difference between a first product and the b^{th} length value; or the a^{th} first metric is a ratio of a first product to the j^{th} lifting size, where the first product is a product of the i^{th} information column quantity and the j^{th} lifting size, and the second difference is the difference between the first product and the b^{th} length value.

Based on this possible implementation, the a^{th} first metric may be determined based on the foregoing two methods, and a plurality of feasible solutions are provided for determining the a^{th} first metric.

With reference to the third aspect and the fourth aspect, in a possible implementation, the j^{th} lifting size is a smallest lifting size that is in the lifting size set and that supports the i^{th} information column quantity in meeting a first condition; or the j^{th} lifting size is a smallest lifting size that is in the lifting size set and whose value is equal to

$${n}^{⌈ {log}_{n} ( \frac{K}{{K}_{i} q} ) ⌉} q ;$$

or the j^{th} lifting size is a smallest lifting size that is in the lifting size set and whose value is equal to

$$⌈ \frac{K}{{K}_{i} q} ⌉ q ,$$

where n is an integer greater than or equal to 2, and K is the length of the information bit sequence; Kᵢ is the i^{th} information column quantity in the information column quantity set, and q is a positive integer; and the first condition is that a product of the i^{th} information column quantity and the lifting size in the lifting size set is greater than or equal to the length of the information bit sequence.

Based on this possible implementation, the lifting size corresponding to the i^{th} information column quantity may be determined by using the foregoing three methods, so that the lifting size corresponding to each information column quantity may be determined. In addition, determining, based on

$${n}^{⌈ {log}_{n} ( \frac{K}{{K}_{i} q} ) ⌉} q or ⌈ \frac{K}{{K}_{i} q} ⌉ q ,$$

the lifting size corresponding to the i^{th} information column quantity has lower computational complexity than determining the lifting size corresponding to the i^{th} information column quantity by using the first method, thereby improving working efficiency.

With reference to the first aspect and the second aspect, in a possible implementation, when q is a prime number, the j^{th} lifting size is the smallest lifting size that is in the lifting size set and whose value is equal to

$$⌈ \frac{K}{{K}_{i} q} ⌉ q .$$

Based on this possible implementation, when q is a prime number, occurrence of a short cycle may be avoided from three aspects. To be specific, in a first aspect, a girth of a Tanner graph is increased as much as possible (the girth is defined as a length of a shortest cycle); in a second aspect, a quantity of short cycles is reduced as much as possible when the girth cannot be increased; and in a third aspect, when the quantity of short cycles cannot be reduced, overlapping between short cycles or presence of a large quantity of common edges between short cycles are avoided.

With reference to the third aspect and the fourth aspect, in a possible implementation, the i^{th} information column quantity is a smallest information column quantity that is in the information column quantity set and that supports the j^{th} lifting size in meeting a first condition; or the i^{th} information column quantity is an information column quantity that is in the information column quantity set and whose value is equal to

$$\frac{K}{{Z}_{j}} .$$

Based on this possible implementation, the information column quantity corresponding to the j^{th} lifting size may be determined by using the foregoing two methods, so that the information column quantity corresponding to each lifting size may be determined. In addition, determining, based on

$$\frac{K}{{Z}_{j}} ,$$

the information column quantity corresponding to the j^{th} lifting size has lower computational complexity than determining the information column quantity corresponding to the j^{th} lifting size by using the first method, thereby improving working efficiency.

With reference to the third aspect and the fourth aspect, in a possible implementation, the information column quantity set includes I information column quantities; and the lifting size set includes J lifting sizes, where 1≤i≤I, and 1≤j≤J.

Based on this possible implementation, a quantity of information column quantities in the information column quantity set may be determined, and a quantity of lifting sizes in the lifting size set may be determined.

With reference to the third aspect and the fourth aspect, in a possible implementation, an information column quantity corresponding to each length value is determined based on a smallest value of C first metrics; or H first metrics are determined based on C first metrics, and an information column quantity corresponding to each length value is determined based on the H first metrics, where C is greater than or equal to 1, an h^{th} first metric in the H first metrics is less than or equal to a first threshold corresponding to the h^{th} first metric, His greater than or equal to 1, and h=1, 2, . . . , H.

Based on this possible implementation, the target information column quantity and the target lifting size are determined based on the smallest value, so that a difference between the length value and the product of the target information column quantity and the target lifting size can be minimized. In this way, degree distribution of the base graph and integrity of the base graph can be protected, and decoding performance can be improved. The target information column quantity and the target lifting size are determined based on the H first metrics, so that more feasible solutions can be provided for determining the target information column quantity and the target lifting size, and the information column quantity corresponding to each length value can be determined based on an actual communication status, thereby improving flexibility in determining the information column quantity corresponding to each length value. In this way, degree distribution of the base graph and integrity of the base graph can be protected, and decoding performance can be improved.

With reference to the third aspect and the fourth aspect, in a possible implementation, a first threshold corresponding to the a^{th} first metric is determined based on a lifting size corresponding to the a^{th} first metric.

Based on this possible implementation, a feasible method is provided for determining the first threshold corresponding to the first metric. The target information column quantity and the target lifting size are determined by using the first metric that is less than the first threshold. In this way, degree distribution of the base graph and integrity of the base graph can be protected, and decoding performance can be improved.

With reference to the third aspect and the fourth aspect, in a possible implementation, the first threshold corresponding to the a^{th} first metric is any one of the following: Zc, 2Zc, 3/2Zc, ½Zc, ⅓Zc, or ¼Zc; or the first threshold corresponding to the a^{th} first metric is any one of the following: 1, 2, 3/2, ½, ⅓, or ¼, where Zc is the lifting size corresponding to the a^{th} first metric.

Based on this possible implementation, optional values of the first threshold corresponding to the first metric are proposed, so that more feasible solutions are provided for determining the first threshold corresponding to the first metric, and the first threshold corresponding to the first metric may be determined based on an actual communication status, thereby improving working efficiency and improving flexibility in determining the first threshold.

With reference to the third aspect and the fourth aspect, in a possible implementation, when there are at least two smallest values, the information column quantity corresponding to each length value is a largest or smallest one of at least two information column quantities corresponding to the at least two smallest values; or when there are at least two smallest values, the information column quantity corresponding to each length value is an information column quantity corresponding to a largest or smallest one of at least two lifting sizes corresponding to the at least two smallest values; or when there are at least two smallest values, the information column quantity corresponding to each length value is determined, based on first indication information, from at least two information column quantities corresponding to the at least two smallest values; or when there are at least two smallest values, the information column quantity corresponding to each length value is determined, based on first indication information, from information column quantities corresponding to at least two lifting size corresponding to the at least two smallest values, where the first indication information indicates a communication scenario.

Based on this possible implementation, when there are at least two smallest values, the target information column quantity and the target lifting size may be determined according to the foregoing several methods, and the target information column quantity and the target lifting size may be determined based on different communication requirements, so that the target information column quantity and the target lifting size can be determined more flexibly, thereby providing a plurality of feasible solutions for determining the target information column quantity and the target lifting size. In this way, degree distribution of the base graph and integrity of the base graph can be protected for different communication requirements, and decoding performance can be improved.

With reference to the third aspect and the fourth aspect, in a possible implementation, when His greater than 1, the information column quantity corresponding to each length value is a largest or smallest one of H information column quantities corresponding to H first metrics; or when H is greater than 1, the information column quantity corresponding to each length value is an information column quantity corresponding to a largest or smallest one of H lifting sizes corresponding to H first metrics; or when H is greater than 1, the information column quantity corresponding to each length value is determined, based on first indication information, from H information column quantities corresponding to H first metrics; or when H is greater than 1, the information column quantity corresponding to each length value is determined, based on first indication information, from information column quantities corresponding to H lifting sizes corresponding to H first metrics, where the first indication information indicates a communication scenario.

Based on this possible implementation, when His greater than 1, the target information column quantity and the target lifting size may be determined based on different communication requirements, so that the target information column quantity and the target lifting size can be determined more flexibly, thereby providing a plurality of feasible solutions for determining the target information column quantity and the target lifting size. In this way, degree distribution of the base graph and integrity of the base graph can be protected for different communication requirements, and decoding performance can be improved.

With reference to the third aspect and the fourth aspect, in a possible implementation, the code length interval and the information column quantity corresponding to each code length interval are determined based on the information column quantity corresponding to each length value.

Based on this possible implementation, code length intervals corresponding to a same information column quantity may be determined based on the information column quantity corresponding to each length value, so that a feasible solution is provided for determining the code length interval and the information column quantity corresponding to each code length interval.

With reference to the third aspect and the fourth aspect, in a possible implementation, a lifting size corresponding to the target information column quantity is determined as the target lifting size.

Based on this possible implementation, after the target information column quantity is determined, the target lifting size may be determined based on the lifting size corresponding to the target information column quantity, and it may be ensured that the difference between the length of the information bit sequence and the product of the target information column quantity and the target lifting size is relatively small. In this way, degree distribution of the base graph and integrity of the base graph can be protected, and decoding performance can be improved.

With reference to the third aspect and the fourth aspect, in a possible implementation, the first information indicates that an information column quantity corresponding to a first code length interval (500, 570) is 24, and an information column quantity corresponding to a second code length interval (571, 600) is 26, and an information column quantity corresponding to a third code length interval is 22, where the third code length interval is a code length interval less than the first code length interval and greater than the second code length interval; or the first information indicates that an information column quantity corresponding to first code length intervals (500, 570) and (700, 770) is 24, and an information column quantity corresponding to second code length intervals (571, 600) and (771, 800) is 26, and an information column quantity corresponding to a third code length interval is 22, where the third code length interval is a code length interval other than the first code length intervals and the second code length intervals; or the first information indicates that an information column quantity corresponding to first code length intervals (703, 728) and (781, 832) is 8, and an information column quantity corresponding to second code length intervals (625, 650) and (875, 910) is 10, and an information column quantity corresponding to a third code length interval is 6, where the third code length interval is a code length interval other than the first code length intervals and the second code length intervals.

Based on this possible implementation, the code length interval and the information column quantity corresponding to the code length interval are determined, so that the target information column quantity can be explicitly determined based on the code length interval corresponding to the length of the information bit sequence, thereby reducing computational complexity and improving working efficiency.

With reference to the third aspect and the fourth aspect, in a possible implementation, one or more candidate information column quantities and one or more candidate lifting sizes are determined, based on a code length of the information bit sequence, from the information column quantity set and the lifting size set that are associated with the base graph; or one or more candidate information column quantities and one or more candidate lifting sizes are determined, based on a code length and a code rate of the information bit sequence, from the information column quantity set and the lifting size set that are associated with the base graph; or one or more candidate information column quantities and one or more candidate lifting sizes are determined, based on the first indication information, from the information column quantity set and the lifting size set that are associated with the base graph.

Based on this possible implementation, one or more candidate information column quantities and one or more candidate lifting sizes are determined, so that a range for determining the target information column quantity and the target lifting size can be narrowed, thereby reducing computational complexity and improving working efficiency.

With reference to the first aspect, the second aspect, the third aspect, and the fourth aspect, in a possible implementation, target information columns are determined, based on the target information column quantity and an indication sequence, from the base graph corresponding to the information bit sequence, where the indication sequence indicates positions of information columns in the base graph.

Based on this possible implementation, the information columns in the base graph may be determined based on the target information column quantity and the indication sequence. In an encoding process, bits may be inserted based on the target information column, so that filler bits can be prevented, as much as possible, from being located at last positions in the information columns, and some filler bits may be located at intermediate positions. In this way, degree distribution of the base graph and integrity of the base graph can be protected, and decoding performance can be improved.

With reference to the first aspect, the second aspect, the third aspect, and the fourth aspect, in a possible implementation, a length of the indication sequence is a maximum information column quantity corresponding to the base graph.

Based on this possible implementation, the indication sequence corresponds to a quantity of information columns of the base graph, so that a case in which the target information columns cannot be determined based on the indication sequence after the target information column quantity is determined can be avoided as much as possible.

With reference to the first aspect, the second aspect, the third aspect, and the fourth aspect, in a possible implementation, elements of the indication sequence correspond to columns of the base graph.

Based on this possible implementation, the elements of the indication sequence correspond to the columns of the base graph, and an order of the information columns of the base graph may be changed when the target information columns are being determined, thereby improving encoding performance.

With reference to the first aspect, the second aspect, the third aspect, and the fourth aspect, in a possible implementation, first T elements of the indication sequence are determined based on the target information column quantity T; and information columns that are in the base graph and that correspond to the first T elements are determined as one or more target information columns, where T is a positive integer.

Based on this possible implementation, the corresponding information columns in the base graph may be determined based on the indication sequence. In the encoding process, bits may be inserted based on the information columns, so that filler bits can be prevented, as much as possible, from being located at last positions in the information columns, and some filler bits may be located at intermediate positions. In this way, degree distribution of the base graph and integrity of the base graph can be protected, and decoding performance can be improved.

With reference to the first aspect, the second aspect, the third aspect, and the fourth aspect, in a possible implementation, the indication sequence is determined based on the length and the code rate of the information bit sequence; or the indication sequence is determined based on first indication information, where the first indication information indicates a communication scenario.

Based on this possible implementation, the indication sequence may be determined based on the length and the code rate of the information bit sequence, or may be determined based on the communication scenario. The indication sequence may be determined based on an actual communication status, to meet different communication requirements.

With reference to the first aspect, the second aspect, the third aspect, and the fourth aspect, in a possible implementation, the indication sequence is {1, 2, 14, 5, 6, 7, 9, 8, 10, 11, 17, 19, 13, 3, 19, 16, 17, 19, 19, 21, 22, 4}; or the indication sequence is {1, 2, 5, 6, 7, 9, 8, 10, 3, 4}.

Based on this possible implementation, several possible indication sequences are proposed, to provide more feasible solutions for determining the target information columns, thereby meeting different communication requirements.

According to a fifth aspect, a communication apparatus is provided, and configured to implement the method according to the first aspect. The communication apparatus may be the sending device in the first aspect, or an apparatus or a component included in the sending device, for example, a chip.

The communication apparatus includes a corresponding module, unit, or means for implementing the foregoing method. The module, unit, or means may be implemented by hardware, software, or hardware executing corresponding software. The hardware or software includes one or more modules or units corresponding to the foregoing functions.

In some possible implementations, the communication apparatus may include a processing module and a transceiver module. The transceiver module may include a sending module and a receiving module that are respectively configured to implement a sending function and a receiving function in any one of the first aspect and the possible implementations of the first aspect. The processing module may be configured to implement a processing function in any one of the first aspect and the possible implementations of the first aspect. For example, the processing module is configured to determine, based on an information bit sequence, an information column quantity set associated with a base graph corresponding to the information bit sequence and a lifting size set associated with the base graph; the processing module is further configured to determine a target information column quantity and a target lifting size based on the information column quantity set and the lifting size set, where the target information column quantity and the target lifting size are determined by comparing X first metrics, an x^{th} first metric in the X first metrics is determined based on a length of the information bit sequence, an i^{th} information column quantity in the information column quantity set, and a j^{th} lifting size in the lifting size set, and the i^{th} information column quantity corresponds to the j^{th} lifting size; X is greater than or equal to 2; and x=1, 2, . . . , X; and the processing module is further configured to encode the information bit sequence based on the target information column quantity and the target lifting size, to obtain an encoded bit sequence.

Optionally, the transceiver module and the processing module of the communication apparatus in the fifth aspect may further perform corresponding functions in any one of the first aspect or the possible implementations of the first aspect. For details, refer to the detailed descriptions in the method examples. For beneficial effects that can be achieved, refer to the foregoing related content.

According to a sixth aspect, a communication apparatus is provided, and configured to implement the method according to the second aspect. The communication apparatus may be the receiving device in the second aspect, or an apparatus or a component included in the receiving device, for example, a chip.

The communication apparatus includes a corresponding module, unit, or means for implementing the foregoing method. The module, unit, or means may be implemented by hardware, software, or hardware executing corresponding software. The hardware or software includes one or more modules or units corresponding to the foregoing functions.

In some possible implementations, the communication apparatus may include a processing module and a transceiver module. The transceiver module may include a sending module and a receiving module that are respectively configured to implement a sending function and a receiving function in any one of the second aspect and the possible implementations of the second aspect. The processing module may be configured to implement a processing function in any one of the second aspect and the possible implementations of the second aspect. For example, the transceiver module is configured to obtain to-be-decoded information from a sending device; and the processing module is configured to decode the to-be-decoded information based on a target information column quantity and a target lifting size, to obtain a decoded information bit sequence, where the target information column quantity and the target lifting size are determined by comparing X first metrics, an x^{th} first metric in the X first metrics is determined based on a length of the information bit sequence, an i^{th} information column quantity in an information column quantity set, and a j^{th} lifting size in a lifting size set, and the i^{th} information column quantity corresponds to the j^{th} lifting size; X is greater than or equal to 2; x=1, 2, . . . , X; and the information column quantity set and the lifting size set are associated with a base graph corresponding to the information bit sequence.

Optionally, the transceiver module and the processing module of the communication apparatus in the sixth aspect may further perform corresponding functions in any one of the second aspect or the possible implementations of the second aspect. For details, refer to the detailed descriptions in the method examples. For beneficial effects that can be achieved, refer to the foregoing related content.

According to a seventh aspect, a communication apparatus is provided, and configured to implement the method according to the third aspect. The communication apparatus may be the sending device in the third aspect, or an apparatus or a component included in the sending device, for example, a chip.

The communication apparatus includes a corresponding module, unit, or means for implementing the foregoing method. The module, unit, or means may be implemented by hardware, software, or hardware executing corresponding software. The hardware or software includes one or more modules or units corresponding to the foregoing functions.

In some possible implementations, the communication apparatus may include a processing module and a transceiver module. The transceiver module may include a sending module and a receiving module that are respectively configured to implement a sending function and a receiving function in any one of the third aspect and the possible implementations of the third aspect. The processing module may be configured to implement a processing function in any one of the third aspect and the possible implementations of the third aspect. For example, the processing module is configured to determine, based on first information, a code length interval corresponding to an information bit sequence, and determine an information column quantity corresponding to the code length interval as a target information column quantity, where the first information indicates an information column quantity corresponding to each of a plurality of code length intervals; the code length interval and the information column quantity corresponding to each code length interval are determined by comparing A first metrics; an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size; A is greater than or equal to 2; the information column quantity set and the lifting size set are associated with a base graph corresponding to the length value; a=1, 2, . . . , A; and the code length interval includes B length values, and 1≤b≤B; the processing module is further configured to determine a target lifting size based on the target information column quantity and a length of the information bit sequence; and the processing module is further configured to encode the information bit sequence based on the target information column quantity and the target lifting size, to obtain an encoded bit sequence.

Optionally, the transceiver module and the processing module of the communication apparatus in the seventh aspect may further perform corresponding functions in any one of the third aspect or the possible implementations of the third aspect. For details, refer to the detailed descriptions in the method examples. For beneficial effects that can be achieved, refer to the foregoing related content.

According to an eighth aspect, a communication apparatus is provided, and configured to implement the method according to the fourth aspect. The communication apparatus may be the receiving device in the fourth aspect, or an apparatus or a component included in the receiving device, for example, a chip.

The communication apparatus includes a corresponding module, unit, or means for implementing the foregoing method. The module, unit, or means may be implemented by hardware, software, or hardware executing corresponding software. The hardware or software includes one or more modules or units corresponding to the foregoing functions.

In some possible implementations, the communication apparatus may include a processing module and a transceiver module. The transceiver module may include a sending module and a receiving module that are respectively configured to implement a sending function and a receiving function in any one of the fourth aspect and the possible implementations of the fourth aspect. The processing module may be configured to implement a processing function in any one of the fourth aspect and the possible implementations of the fourth aspect. For example, the transceiver module is configured to obtain to-be-decoded information from a sending device; the processing module is configured to determine a length of an information bit sequence corresponding to the to-be-decoded information; the processing module is further configured to determine, based on first information, a code length interval corresponding to the length of the information bit sequence, and determine an information column quantity corresponding to the code length interval as a target information column quantity, where the first information indicates an information column quantity corresponding to each of a plurality of code length intervals; the code length interval and the information column quantity corresponding to each code length interval are determined by comparing A first metrics; an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size; A is greater than or equal to 2; a=1, 2, . . . , A; the information column quantity set and the lifting size set are associated with a base graph corresponding to the length value; and the code length interval includes B length values, and 1≤b≤B; the processing module is further configured to determine a target lifting size based on the target information column quantity and a length of the information bit sequence; and the processing module is further configured to decode the to-be-decoded information based on the target information column quantity and the target lifting size, to obtain a decoded information bit sequence.

Optionally, the transceiver module and the processing module of the communication apparatus in the eighth aspect may further perform corresponding functions in any one of the fourth aspect or the possible implementations of the fourth aspect. For details, refer to the detailed descriptions in the method examples. For beneficial effects that can be achieved, refer to the foregoing related content.

According to a ninth aspect, a communication apparatus is provided, including at least one processor. The processor is configured to enable, by executing computer instructions stored in a memory or by using a logic circuit, the communication apparatus to perform the method according to any one of the foregoing aspects or the possible implementations of any one of the foregoing aspects. The communication apparatus may be the sending device in any one of the first aspect or the possible implementations of the first aspect, or an apparatus or a component included in the sending device, for example, a chip; or the communication apparatus may be the receiving device in any one of the second aspect or the possible implementations of the second aspect, or an apparatus or a component included in the receiving device, for example, a chip; or the communication apparatus may be the sending device in any one of the third aspect or the possible implementations of the third aspect, or an apparatus or a component included in the sending device, for example, a chip; or the communication apparatus may be the receiving device in any one of the fourth aspect or the possible implementations of the fourth aspect, or an apparatus or a component included in the receiving device, for example, a chip.

In some possible implementations, the communication apparatus further includes a memory, configured to store computer instructions and/or a configuration file of the logic circuit. Optionally, the memory and the processor are integrated together, or the memory is independent of the processor.

According to a tenth aspect, a communication apparatus is provided, including a processor and a communication interface. The communication interface is configured to input and/or output a signal. The processor is configured to execute a computer program or instructions, to enable the communication apparatus to perform the method in any one of the foregoing aspects. The communication apparatus may be the sending device in any one of the first aspect or the possible implementations of the first aspect, or an apparatus or a component included in the sending device, for example, a chip; or the communication apparatus may be the receiving device in any one of the second aspect or the possible implementations of the second aspect, or an apparatus or a component included in the receiving device, for example, a chip; or the communication apparatus may be the sending device in any one of the third aspect or the possible implementations of the third aspect, or an apparatus or a component included in the sending device, for example, a chip; or the communication apparatus may be the receiving device in any one of the fourth aspect or the possible implementations of the fourth aspect, or an apparatus or a component included in the receiving device, for example, a chip.

In some possible implementations, the communication interface is an interface circuit, and is configured to read and write computer instructions. For example, the interface circuit is configured to receive computer-executable instructions (the computer-executable instructions are stored in a memory, and may be directly read from the memory, or may be read via another component), and transmit the computer-executable instructions to the processor.

In some possible implementations, the communication interface is configured to communicate with a module outside the communication apparatus.

In some possible implementations, the communication apparatus may be a chip or a chip system. When the apparatus is the chip system, the chip system may include a chip, or may include a chip and another discrete component.

According to an eleventh aspect, a communication apparatus is provided, including a logic circuit and an interface circuit. The interface circuit is configured to input information and/or output information. The logic circuit is configured to perform the method in any one of the foregoing aspects, and perform processing and/or generate to-be-output information based on the input information. The communication apparatus may be the sending device in any one of the first aspect or the possible implementations of the first aspect, or an apparatus or a component included in the sending device, for example, a chip; or the communication apparatus may be the receiving device in any one of the third aspect or the possible implementations of the third aspect, or an apparatus or a component included in the receiving device, for example, a chip; or the communication apparatus may be the sending device in any one of the fourth aspect or the possible implementations of the fourth aspect, or an apparatus or a component included in the sending device, for example, a chip; or the communication apparatus may be the receiving device in any one of the second aspect or the possible implementations of the second aspect, or an apparatus or a component included in the receiving device, for example, a chip.

According to a twelfth aspect, a computer-readable storage medium is provided. The computer-readable storage medium stores a computer program or instructions. When the computer program or the instructions are executed by a processor, the method in any one of the foregoing aspects is performed.

According to a thirteenth aspect, a computer program product is provided. When the computer program product is executed by a processor, the method according to any one of the foregoing aspects is performed.

It may be understood that when the communication apparatus provided in any one of the fifth aspect to the eleventh aspect is a chip, the foregoing sending action/function may be understood as outputting information, and the foregoing receiving action/function may be understood as inputting information.

For technical effects brought by any one of the fifth aspect to the thirteenth aspect or the implementations thereof, refer to the technical effects brought by any one of the first aspect or the possible implementations of the first aspect, or refer to the technical effects brought by any one of the second aspect or the possible implementations of the second aspect, or refer to the technical effects brought by any one of the third aspect or the possible implementations of the third aspect, or refer to the technical effects brought by any one of the fourth aspect or the possible implementations of the fourth aspect. Details are not described herein again.

According to a fourteenth aspect, a communication system is provided. The communication system includes the sending device according to any one of the first aspect or the possible implementations of the first aspect, the receiving device according to any one of the second aspect or the possible implementations of the second aspect, the sending device according to any one of the third aspect or the possible implementations of the third aspect, and the receiving device according to any one of the fourth aspect or the possible implementations of the fourth aspect.

### BRIEF DESCRIPTION OF DRAWINGS

FIG. 1 is a diagram of information transmission according to an embodiment of this application;

FIG. 2 is a schematic flowchart for determining a quantity of shortened bits according to an embodiment of this application;

FIG. 3 is a diagram of a communication system according to an embodiment of this application;

FIG. 4 is a diagram of a communication system according to an embodiment of this application;

FIG. 5 is a diagram of a structure of a communication apparatus according to an embodiment of this application;

FIG. 6 is an interaction diagram of a sequence transmission method according to an embodiment of this application;

FIG. 7 is a schematic flowchart for determining a candidate information column quantity and a candidate lifting size according to an embodiment of this application;

FIG. 8 is a schematic flowchart of an encoding method according to an embodiment of this application;

FIG. 9A to FIG. 9C are diagrams for determining an information column index according to an embodiment of this application;

FIG. 10A and FIG. 10B are diagrams for re-encoding an information column index according to an embodiment of this application;

FIG. 11 is an interaction diagram of a sequence transmission method according to an embodiment of this application;

FIG. 12 is a diagram illustrating a code length interval and a target information column quantity according to an embodiment of this application;

FIG. 13 is a diagram illustrating a code length interval and a target information column quantity according to an embodiment of this application;

FIG. 14 is a simulation diagram illustrating different methods for determining a quantity of shortened bits according to an embodiment of this application;

FIG. 15 is a simulation diagram illustrating different methods for determining a quantity of shortened bits according to an embodiment of this application;

FIG. 16 is a simulation diagram illustrating a relationship between a lifting size and a length of an information bit sequence according to an embodiment of this application;

FIG. 17 is a diagram of a structure of a sending device according to an embodiment of this application;

FIG. 18 is a diagram of a structure of a receiving device according to an embodiment of this application; and

FIG. 19 is a diagram of a structure of another communication apparatus according to an embodiment of this application.

### DESCRIPTION OF EMBODIMENTS

The following describes implementations of embodiments of this application in detail with reference to accompanying drawings in this specification.

In the descriptions of this application, unless otherwise specified, the character “/” indicates an “or” relationship between associated objects. For example, A/B may represent A or B. The term “and/or” in this application merely describes an association relationship between associated objects and indicates that three relationships may exist. For example, A and/or B may represent the following three cases. Only A exists, both A and B exist, and only B exists, where A and B may be singular or plural.

In the descriptions of this application, “a plurality of” means two or more, unless otherwise specified. The term “at least one of the following items (pieces)” or an expression similar to the term indicates any combination of these items, including a single item (piece) or any combination of a plurality of items (pieces). For example, at least one item (piece) of a, b, or c may represent a, b, c, a and b, a and c, b and c, or a and b and c, where a, b, and c may be singular or plural.

In addition, to clearly describe the technical solutions in embodiments of this application, terms such as “first” and “second” are used in embodiments of this application to distinguish between same items or similar items having basically same functions and purposes. A person skilled in the art may understand that the terms such as “first” and “second” do not limit a quantity or an execution order, and the terms such as “first” and “second” do not indicate a definite difference.

In embodiments of this application, the term “example”, “for example”, or the like is used to represent an example, an illustration, or a description. Any embodiment or design scheme described as “example” or “for example” in embodiments of this application should not be construed as being more preferred or advantageous than another embodiment or design scheme. Exactly, use of the terms such as “example” or “for example” is intended to present a related concept in a specific manner for ease of understanding.

It may be understood that, an “embodiment” mentioned throughout this specification means that particular features, structures, or characteristics related to this embodiment are included in at least one embodiment of this application. Therefore, embodiments in the entire specification are not necessarily a same embodiment. In addition, these specific features, structures, or characteristics may be combined in one or more embodiments in any appropriate manner. It may be understood that sequence numbers of processes do not mean execution orders in various embodiments of this application. The execution orders of the processes should be determined based on functions and internal logic of the processes, and should not be construed as any limitation on implementation processes of embodiments of this application.

It may be understood that in some scenarios, some optional features in embodiments of this application may be independently implemented without depending on another feature, for example, a solution on which the optional features are currently based, to resolve a corresponding technical problem and achieve corresponding effects. Alternatively, in some scenarios, the optional features may be combined with other features based on a requirement. Correspondingly, apparatuses provided in embodiments of this application may also correspondingly implement these features or functions. Details are not described herein.

In this application, unless otherwise specified, mutual reference may be made between same or similar parts of different embodiments. In embodiments of this application, unless otherwise specified or there is a logic conflict, terms and/or descriptions between different embodiments are consistent and may be mutually referenced, and technical features in different embodiments may be combined into a new embodiment based on an internal logical relationship thereof. The following implementations of this application are not intended to limit the protection scope of this application.

For ease of understanding of the technical solutions in embodiments of this application, the following first briefly describes technologies related to this application.

### (1) Signal Transmission

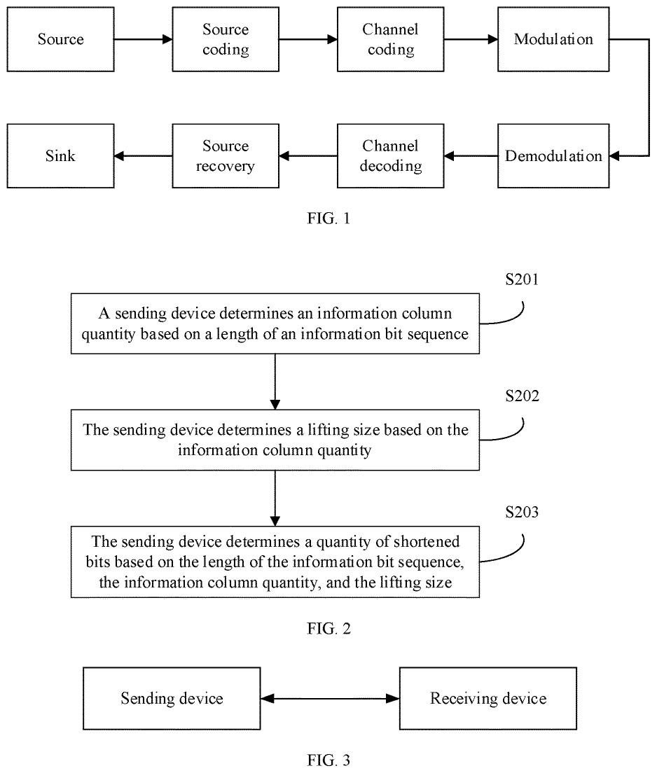

In a communication system, as shown in FIG. 1, information sent by a source may undergo processes such as source coding, channel coding, and modulation to form a signal. After the signal is transmitted through a channel, a sink receives the signal, and the signal undergoes processes such as demodulation, channel decoding, and source recovery to become information. In this way, signal transmission can be implemented between the sink and the source.

Types of channel coding mainly include linear block codes, convolutional codes, concatenated codes, LDPC codes, and the like.

### (2) LDPC Code

An LDPC code, that is, a low-density parity-check code, is a channel coding scheme that closely approaches a Shannon limit and has characteristics of good coding performance and low complexity. The LDPC code has been determined by the 3rd Generation Partnership Project Protocol (3GPP) as a channel coding scheme for a 5th generation (5G) mobile communication system.

With the LDPC code, channel coding can be implemented by using a generator matrix or a parity-check matrix. In mainstream applications, the LDPC code uses a quasi-cyclic (QC) structure. In other words, setting a shift value of each circulant can avoid short cycles and other detrimental structures as much as possible, and can further increase a code distance.

### (3) LDPC Code Decoding Algorithm

Optionally, LDPC code decoding algorithms may be a minimum sum (MS) decoding algorithm and a belief propagation (BP) decoding algorithm.

The BP decoding algorithm has relatively good decoding performance, but requires a relatively large amount of information storage and has relatively high computational complexity, which is not conducive to hardware implementation.

The MS decoding algorithm has relatively poor decoding performance, but has relatively low computational complexity and is easier to implement in hardware. In an actual communication system, an offset-MS decoding algorithm and a normalized MS decoding algorithm are usually used.

### (4) Base Graph

A base graph model of a QC-LDPC code may be represented as BG=(X, Y, F), where X is a corresponding variable, Y is a parity-check equation associated with the corresponding variable, and F is an edge relationship between the corresponding variable and the parity-check equation associated with the corresponding variable.

Optionally, a base graph of the QC-LDPC code may be expanded to a circulant permutation matrix. In other words, after QC expansion with a lifting size of Z, the base graph of the QC-LDPC code yields a Tanner graph (which may also be referred to as a parity-check matrix).

The Tanner graph may be represented as: G=(V, C, E), where V is a variable node, C is a check node, and E is an edge relationship between the variable node and the check node.

Optionally, based on the Tanner graph and an expansion factor Z, it may be determined that a quantity of columns of the parity-check matrix is |V|=Z|X|, and that a quantity of non-zero elements of the parity-check matrix is |E|=Z|F|.

### (5) Lifting Size Set

In the 5G mobile communication system, a length of a supported information bit sequence ranges from 1 to 8448, and a base graph may be a base graph 1 (BG1) and a base graph 2 (BG2).

A same base graph may use different lifting sizes to adapt to rate matching for information bit sequences of different lengths.

For example, content of a lifting size set may be shown in the following Table 1.

TABLE 1
Lifting size set

| Set index (i) | Lifting size set |
|---|---|
| 0 | {2, 4, 8, 16, 32, 64, 128, 256} |
| 1 | {3, 6, 12, 24, 48, 96, 192, 384} |
| 2 | {5, 10, 20, 40, 80, 160, 319} |
| 3 | {7, 14, 28, 56, 112, 224} |
| 4 | {9, 18, 36, 72, 144, 288} |
| 5 | {11, 22, 44, 88, 176, 352} |
| 6 | {13, 26, 52, 104, 208} |
| 7 | {15, 30, 60, 120, 240} |

An element corresponding to a set index i of a lifting size set may be expressed as aᵢ×2^{k}^{ᵢ}, aᵢ may be referred to as a base, aᵢ∈{2, 3, 5, 7, 9, 11, 13, 19}, kᵢ is a natural number set, an initial value of kᵢ is 1, and max (kᵢ)={7, 7, 6, 5, 5, 5, 4, 4}.

For example, the set index i is 1, max (k₁) is 7, k₁={0, 1, 2, 3, 4, 5, 6, 7}, and @1=2. In this case, a lifting size set associated with the set index i of 1 is {2, 4, 8, 16, 32, 64, 128, 256}.

For another example, the set index i is 7, max (k₇) is 4, k₇={0, 1, 2, 3, 4}, and a₇=15. In this case, a lifting size set associated with the set index i of 7 is {15, 30, 60, 120, 240}.

### (6) Rate Matching

To support flexible scheduling and improve a system throughput, rate matching needs to be performed on the LDPC code. Specific steps may be shown in FIG. 2.
S201: A sending device determines an information column quantity based on a length of an information bit sequence.

The information column quantity may be an information column quantity corresponding to the base graph 1, or may be an information column quantity corresponding to the base graph 2.
S202: The sending device determines a lifting size based on the information column quantity.
S203: The sending device determines a quantity of shortened bits based on the length of the information bit sequence, the information column quantity, and the lifting size.

The sending device may implement rate matching based on the quantity of shortened bits.

For example, the quantity of shortened bits may be expressed as kb×Z_{c}−K, where kb is the information column quantity, Z, is the lifting size, and K is the length of the information bit sequence.

It may be understood that the foregoing process of determining the quantity of shortened bits is a serial process, that is, determining of the information column quantity is associated only with the length of the information bit sequence and is independent of the lifting size. Further, as the length of the information bit sequence continuously increases, the information column quantity determined based on the length may also continuously increase. Consequently, the determined quantity of shortened bits may increase exponentially, degree distribution of the base graph is damaged, integrity of the base graph is impaired, and decoding performance is degraded. In addition, a same rate matching manner in the communication system needs to support requirements in different scenarios (for example, a high throughput scenario or an ultra-reliable and low latency communications (URLLC) scenario requires a specific rate matching manner). If the information column quantity and the lifting size continue to be determined according to the method in FIG. 2, requirements for rate matching in different scenarios cannot be met, and communication performance may be degraded.

The degree distribution of the base graph may affect column weight distribution of a parity-check matrix. A design objective of the LDPC code is to optimize a decoding threshold, and the column weight distribution is one of main factors that affect the decoding threshold. Therefore, in a rate matching process, particular attention is paid to the degree distribution of the base graph. To be specific, the sending device may determine the base graph based on the length of the information bit sequence, and then determine the column weight distribution of the parity-check matrix, so that the decoding threshold can be optimized based on the column weight distribution.

In the rate matching process, the sending device may determine the quantity of shortened bits based on the information column quantity, the lifting size, and the length of the information bit sequence. Due to presence of shortened bits, some information columns of the base graph may be removed. Consequently, integrity of the base graph may be impaired, and the degree distribution of the base graph may change, resulting in a suboptimal decoding threshold. Therefore, when the sending device determines the information column quantity and the lifting size, the integrity of the base graph and degree distribution of the base graph can be ensured as much as possible, so that the column weight distribution of the parity-check matrix is ensured, thereby improving decoding performance.

In conclusion, how to determine the information column quantity and the lifting size to protect the degree distribution of the base graph and integrity of the base graph and improve decoding performance becomes an urgent problem to be resolved.

To resolve the foregoing technical problem, this application provides a sequence transmission method. The method includes that a sending device determines, based on an information bit sequence, an information column quantity set associated with a base graph corresponding to the information bit sequence and a lifting size set associated with the base graph; determines a target information column quantity and a target lifting size based on the information column quantity set and the lifting size set; encodes the information bit sequence based on the target information column quantity and the target lifting size; and sends an encoded information bit sequence to a receiving device. The base graph corresponds to the information bit sequence; the target information column quantity and the target lifting size are determined by comparing X first metrics, an x^{th} first metric in the X first metrics is determined based on a length of the information bit sequence, an i^{th} information column quantity in the information column quantity set, and a j^{th} lifting size in the lifting size set, and the i^{th} information column quantity corresponds to the j^{th} lifting size; X is greater than or equal to 2; and x=1, 2, . . . , X.

In embodiments of this application, unlike a sending device that determines a target information column quantity based on a length of an information bit sequence and then determines a target lifting size based on the target information column quantity, the sending device in this application may determine the target information column quantity and the target lifting size by comparing the X first metrics. On one hand, more feasible solutions may be provided for determining the target information column quantity and the target lifting size. On the other hand, a difference between a product of the target information column quantity and the target lifting size and the length of the information bit sequence may not increase as the length of the bit sequence increases, and the difference may be relatively small or remain within a specific range. In this way, degree distribution of the base graph and integrity of the base graph can be protected, and decoding performance can be improved.

The technical solutions in embodiments of this application may be applied to various communication systems. The communication system may be a 3GPP communication system, for example, a 4th generation (4G) system, a Long-Term Evolution (LTE) system, a 5G mobile communication system, a new radio (NR) system, a system with LTE-5G hybrid networking, a non-terrestrial communication network (NTN) system, a mobile communication system evolved after 5G, such as 6th generation (6G), a vehicle-to-everything (V2X) system, a device-to-device (D2D) communication system, a machine-to-machine (M2M) communication system, an Internet of Things (IoT), a Narrowband IoT (NB-IoT), another next-generation communication system, an integrated sensing and communication system, a satellite communication system, or the like. The communication system may alternatively be a non-3GPP communication system, for example, a wireless local area network (WLAN) system such as Wi-Fi.

The technical solutions in embodiments of this application may be applied to various communication scenarios, for example, sensing, downlink synchronization, and channel estimation scenarios.

The foregoing communication systems and communication scenarios to which this application is applicable are merely examples for description, communication systems and communication scenarios to which this application is applicable are not limited thereto, and the foregoing descriptions do not constitute any limitation on the solutions of this application.

For example, FIG. 3 is a diagram of a structure of a communication system according to this application. The communication system may include a sending device and a receiving device.

The communication system may complete a specific function, such as synchronization, channel estimation, or sensing.

It should be noted that, unless otherwise specified, the “sending device” in this application may be the sending device itself, or may be a component (for example, a processor, a chip, or a chip system) in the sending device, or may be a logical module or software that can implement all or some functions of the sending device.

It should be noted that, unless otherwise specified, the “receiving device” in this application may be the receiving device itself, or may be a component (for example, a processor, a chip, or a chip system) in the receiving device, or may be a logical module or software that can implement all or some functions of the receiving device.

The sending device may be a terminal device, or may be a network device. This is not limited.

The receiving device may be a terminal device, or may be a network device. This is not limited.

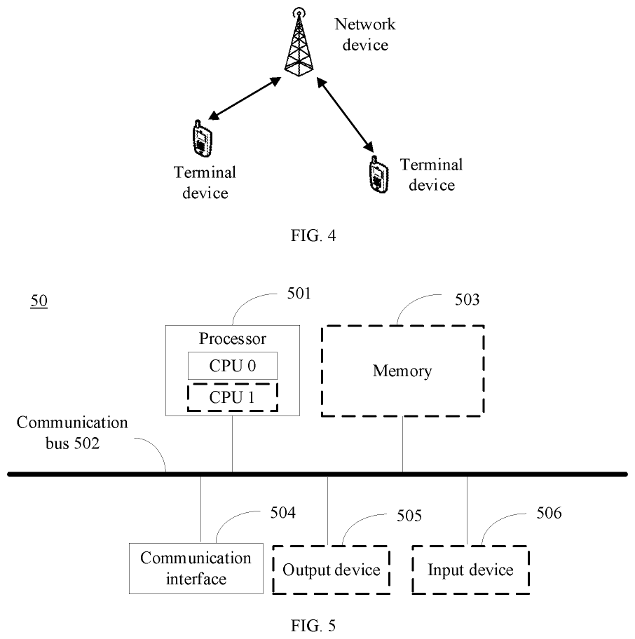

As shown in FIG. 4, the terminal device in embodiments of this application may be located in a beam/cell coverage area of the network device, and the network device may provide a communication service for the terminal device.

The terminal device in FIG. 4 may be a device having a wireless transceiver function or a chip or a chip system that can be disposed in the device, may allow a user to access a network, and is a device configured to provide voice and/or data connectivity for the user. The terminal device may also be referred to as user equipment (UE), a subscriber unit, a terminal, a mobile station (MS), a mobile terminal (MT), or the like.

Optionally, the terminal device in embodiments of this application may be a user-side device configured to implement a wireless communication function, for example, a terminal or a chip that may be used in the terminal. The terminal may be UE, an access terminal, a terminal unit, a terminal station, a mobile station, a remote station, a remote terminal, a mobile device, a wireless communication device, a terminal agent, a terminal apparatus, or the like in a 5G network or a public land mobile network (PLMN) that evolves from 5G. The access terminal may be a cellular phone, a cordless phone, a Session Initiation Protocol (SIP) phone, a wireless local loop (WLL) station, a personal digital assistant (PDA), a handheld device having a wireless communication function, a computing device or another processing device connected to a wireless modem, a vehicle-mounted device, an uncrewed aerial vehicle, a robot, a smart point of sale (POS) machine, customer premises equipment (CPE) or a wearable device, a virtual reality (VR) terminal device, an augmented reality (AR) terminal device, a wireless terminal in industrial control, a wireless terminal in self-driving, a wireless terminal in telemedicine services, a wireless terminal in a smart grid, a wireless terminal in transportation safety, a wireless terminal in a smart city, a wireless terminal in a smart home, or the like. Alternatively, the terminal may be a terminal having a communication function in the IoT, for example, a terminal in V2X (for example, a V2X device), a terminal in D2D communication, or a terminal in M2M communication. The terminal may be mobile or fixed.

The network device in FIG. 4 may be any device that is deployed in an access network and that can perform wireless communication with a terminal device, or may be a chip or a chip system that may be disposed in the device, or may be a logical node or a logical module or a function implemented by software. The network device may be configured to implement functions such as a radio physical control function, resource scheduling and radio resource management, radio access control, and mobility management. Further, the network device may be a device supporting wired access, or may be a device supporting wireless access.

Optionally, the network device in embodiments of this application is a device that connects a terminal device to a wireless network. The network device may be a node in a radio access network (RAN), or may be a base station, and may be referred to as a radio access network node (or device).

For example, the network device may include an evolved NodeB (eNB or e-NodeB) in an LTE system or an LTE-advanced (LTE-A) system, for example, a macro base station eNB and a micro base station eNB in a heterogeneous network scenario. Alternatively, the network device may include a next generation NodeB (gNB) in an NR system. Alternatively, the network device may include a transmission reception point (TRP), a home base station (for example, a home evolved NodeB or a home NodeB (HNB)), a baseband unit (BBU), a baseband unit (BBU) pool, a Wi-Fi access point (AP), or the like. Alternatively, the network device may include a base station in an NTN, to be specific, may be deployed on an aerial platform or a satellite. In the NTN, the network device may serve as a layer 1 (L1) relay, may serve as a base station, or may serve as an integrated access and backhaul (IAB) node. Alternatively, the network device may be a device that is in an IoT and that implements functions of a base station, for example, a device that is in uncrewed aerial vehicle communication, V2X, D2D, or M2M and that implements the functions of the base station.

Alternatively, the network device may be a module or unit that can implement some functions of the base station. For example, the network device may be a central unit (CU), a distributed unit (DU), a CU-control plane (CP), a CU-user plane (UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, the network device may be a network device in an open RAN (ORAN) system or a module of the network device. In the ORAN system, a CU may also be referred to as an open (O)-CU, a DU may also be referred to as an O-DU, a CU-CP may also be referred to as an O-CU-CP, a CU-UP may also be referred to as an O-CU-UP, and an RU may also be referred to as an O-RU. Any one of the CU (or the CU-CP and the CU-UP), the DU, and the RU may be implemented by using a software module, a hardware module, or a combination of a software module and a hardware module.

Optionally, the base station in embodiments of this application may include various forms of base stations, for example, a macro base station, a micro base station (a small cell), a relay station, an access point, a home base station, a TRP, a transmitting point (TP), or a mobile switching center. This is not specifically limited in embodiments of this application.

It should be noted that the communication system described in embodiments of this application is intended to describe the technical solutions in embodiments of this application more clearly, and does not constitute any limitation on the technical solutions provided in embodiments of this application. A person of ordinary skill in the art may learn that the technical solutions provided in embodiments of this application are also applicable to a similar technical problem as a network architecture evolves and a new service scenario emerges.

For example, the new service scenario may be a high throughput scenario, a URLLC scenario, or a low power consumption scenario.

The scenario may be distinguished by using a code length and a code rate of an information bit sequence, or the scenario may be specified in a standard. This is not limited.

For example, the high throughput scenario is a scenario in which a code rate is relatively high (for example, the code rate is greater than or equal to 0.926, 0.917, or ⅚) and a length of an information bit sequence is relatively long (for example, the length of the information bit sequence is 8k to 16k).

For another example, the URLLC scenario is a scenario in which a code rate is relatively low (for example, the code rate is less than or equal to ⅓, ⅖, ⅕, or ⅙) and a code length of an information bit sequence is short-to-medium (for example, the code length of the information bit sequence is less than or equal to 2k).

During specific implementation, the sending device or the receiving device shown in FIG. 3 may use a composition structure shown in FIG. 5, or include components shown in FIG. 5. FIG. 5 is a composition diagram of a communication apparatus 50 according to an embodiment of this application. The communication apparatus 50 may be a sending device, or a chip or a system-on-chip in the sending device; or may be a receiving device, or a chip or a system-on-chip in the receiving device.

As shown in FIG. 5, the communication apparatus 50 includes one or more processors 501. Further, the communication apparatus 50 may further include a communication bus 502 and at least one communication interface (FIG. 5 is merely an example, and an example in which the communication apparatus 50 includes a communication interface 504 and one processor 501 is used for description). Optionally, the communication apparatus 50 may further include a memory 503.

The processor 501 may be a general-purpose central processing unit (CPU), a microprocessor, an application-specific integrated circuit (ASIC), one or more integrated circuits configured to control program execution in the solutions of this application, or a processing core configured to process data (for example, computer program instructions). The processor may be a single-core (single-CPU) processor, or may be a multi-core (multi-CPU) processor.

During specific implementation, in an embodiment, the processor 501 may include one or more CPUs, for example, a CPU 0 and a CPU 1 in FIG. 5.

The communication bus 502 may be a peripheral component interconnect (PCI) bus, an extended industry standard architecture (EISA) bus, or the like. The bus may be classified into an address bus, a data bus, a control bus, and the like. For ease of representation, only one bold line is used for representation in FIG. 5, but this does not mean that there is only one bus or only one type of bus. The communication bus 502 is configured to connect different components in the communication apparatus 50, so that the different components in the communication apparatus 50 may communicate and interact with each other.

The communication interface 504 may be a transceiver module configured to communicate with another device or a communication network. The communication network may be, for example, an Ethernet, a RAN, or a wireless local area network (WLAN). For example, the communication interface 504 may be an apparatus, for example, a transceiver or a transceiver machine. Alternatively, the communication interface 504 may be a transceiver circuit located in the processor 501, and is configured to implement signal input and signal output of the processor.

The memory 503 may be an apparatus with a storage function. For example, the memory 503 may be a read-only memory (ROM) or another type of static storage device that can store static information and instructions, or a random-access memory (RAM) or another type of dynamic storage device that can store information and instructions; or may be an electrically erasable programmable ROM (EEPROM), a compact disc (CD) ROM or another compact disc storage, an optical disc storage (including a compact optical disc, a laser disc, an optical disc, a digital versatile disc (DVD), a BLU-RAY disc, or the like), a magnetic disk storage medium or another magnetic storage device, or any other medium that can be configured to carry or store desired program code in a form of instructions or a data structure and that can be accessed by a computer. However, the memory is not limited thereto. The memory may exist independently, and is connected to the processor by using the communication bus 502. Alternatively, the memory may be integrated with the processor.

For example, the memory 503 is configured to store computer-executable instructions for executing the solutions of this application, and the processor 501 controls execution. The processor 501 is configured to execute the computer-executable instructions stored in the memory 503, to implement the method provided in embodiments of this application.

Alternatively, optionally, in this embodiment of this application, the processor 501 may perform processing-related functions in a method provided in the following embodiments of this application, and the communication interface 504 is responsible for communicating with another device or a communication network. This is not specifically limited in this embodiment of this application.

Optionally, the computer-executable instructions in this embodiment of this application may also be referred to as application program code. This is not specifically limited in this embodiment of this application.

During specific implementation, in an embodiment, the communication apparatus 50 may further include an output device 505 and an input device 506. The output device 505 communicates with the processor 501, and may display information in a plurality of manners. For example, the output device 505 may be a liquid-crystal display (LCD), a light-emitting diode (LED) display device, a cathode-ray tube (CRT) display device, or a projector. The input device 506 communicates with the processor 501, and may receive an input of a user in a plurality of manners. For example, the input device 506 may be a mouse, a keyboard, a touchscreen device, a sensor device, or the like.

It should be noted that the composition structure shown in FIG. 5 does not constitute a limitation on the communication apparatus. In addition to the components shown in FIG. 5, the communication apparatus may include more or fewer components than those shown in the figure, or some components may be combined, or different component arrangements may be used.

With reference to the accompanying drawings, the following describes in detail the sequence transmission method provided in embodiments of this application. It may be understood that, in embodiments of this application, a sending device or a receiving device may perform some or all of steps in embodiments of this application. The steps or operations are merely examples. In embodiments of this application, other operations or variations of various operations may be further performed. In addition, the steps may be performed in an order different from the order presented in embodiments of this application, and not all the operations in embodiments of this application may be performed.

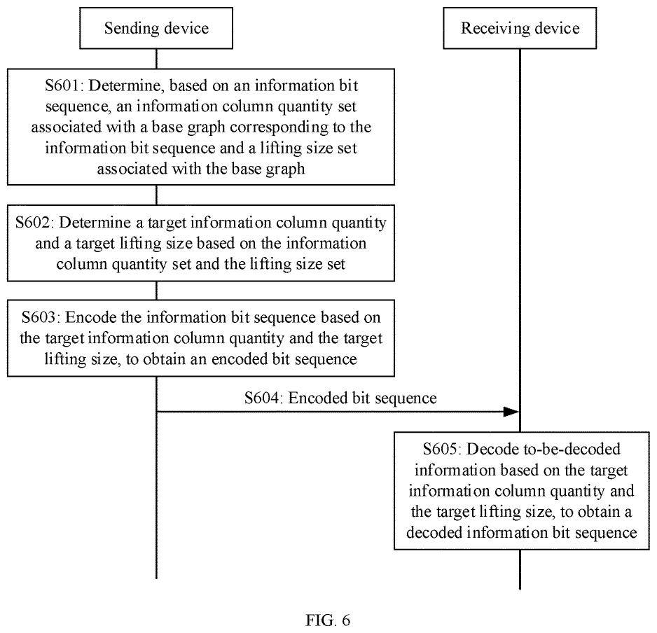

FIG. 6 is an interaction diagram of a sequence transmission method according to an embodiment of this application. The sequence transmission method is described by using interaction between a sending device and a receiving device as an example. Certainly, an action of the sending device in the method may alternatively be performed by an apparatus or a module in the sending device, for example, a chip, a processor, or a processing unit in the sending device. An action of the receiving device in the method may alternatively be performed by an apparatus or a module in the receiving device, for example, a chip, a processor, or a processing unit in the receiving device. This is not specifically limited in this embodiment of this application. In this embodiment of this application, processing performed by a single execution body (for example, the sending device or the receiving device) may alternatively be divided for execution by a plurality of execution bodies, and these execution bodies may be logically and/or physically separated. For example, with reference to FIG. 6, the sequence transmission method includes the following steps.
S601: The sending device determines, based on an information bit sequence, an information column quantity set associated with a base graph corresponding to the information bit sequence and a lifting size set associated with the base graph.

The base graph corresponds to the information bit sequence.

For example, the base graph may be a base graph 1, a base graph 2, or another base graph. This is not limited.

Optionally, the sending device may determine, based on a length and/or a code rate of the information bit sequence, the base graph corresponding to the information bit sequence.

For example, when the length of the information bit sequence is less than or equal to 292, the base graph corresponding to the information bit sequence may be the base graph 2; or when the length of the information bit sequence is less than or equal to 3824 and the code rate is less than or equal to 0.67, the base graph corresponding to the information bit sequence may be the base graph 2; or when the code rate is less than or equal to a threshold (for example, ⅓, ⅖, ⅕, or ⅙), the base graph corresponding to the information bit sequence may be the base graph 2; or when the length of the information bit sequence is greater than 3824, the base graph corresponding to the information bit sequence may be the base graph 1; or when the code rate is greater than a threshold (for example, 0.926, 0.917, or ⅚), the base graph corresponding to the information bit sequence may be the base graph 1.

Certainly, the foregoing is merely an example for description. In another case, the base graph may be the base graph 1, the base graph 2, another base graph, or the like. This is not specifically limited in this embodiment of this application.

Optionally, the length of the information bit sequence may be a length including a CRC check bit, or may be the length of the information bit sequence. This is not limited.
S602: The sending device determines a target information column quantity and a target lifting size based on the information column quantity set and the lifting size set.

For step S602, in this embodiment of this application, the target information column quantity and the target lifting size are determined by comparing X first metrics.

An x^{th} first metric in the X first metrics is determined based on the length of the information bit sequence, an i^{th} information column quantity in a first information column quantity set, and a j^{th} lifting size in a first lifting size set.

X is greater than or equal to 2; and x=1, 2, . . . , X.

The first information column quantity set may include I information column quantities, where 1≤i≤I; and the first lifting size set may include J lifting sizes, where 1≤j≤J.

Optionally, the x^{th} first metric is a difference between a first product and the length of the information bit sequence; or the x^{th} first metric is a ratio of a first difference to the j^{th} lifting size. This is not limited.

The first product is a product of the i^{th} information column quantity and the j^{th} lifting size, and the first difference is the difference between the first product and the length of the information bit sequence.

For example, when the x^{th} first metric is the difference between the first product and the length of the information bit sequence, the x^{th} first metric may be expressed by using the following formula: Kᵢ×Zⱼ−K.

Kᵢ is the i^{th} information column quantity in the information column quantity set, Zⱼ is the j^{th} lifting size in the lifting size set, and K is the length of the information bit sequence.

For another example, when the x^{th} first metric is the ratio of the first difference to the j^{th} lifting size, the x^{th} first metric may be expressed by using the following formula: (Kᵢ×Zⱼ−K)/Zᵢ=Kᵢ−K/Zⱼ.

Kᵢ is the i^{th} information column quantity in the information column quantity set, Zⱼ is the j^{th} lifting size in the lifting size set, and K is the length of the information bit sequence.

It may be understood that Kᵢ may be used as an information column quantity corresponding to Zⱼ, and correspondingly, Zⱼ may be used as a lifting size corresponding to Kᵢ, that is, the i^{th} information column quantity corresponds to the j^{th} lifting size. This application proposes two possible implementations for determining a correspondence between an information column quantity and a lifting size.

In a possible implementation, a lifting size corresponding to the i^{th} information column quantity may be the j^{th} lifting size.

In a first possible embodiment, the j^{th} lifting size may be a smallest lifting size that is in the lifting size set and that supports the i^{th} information column quantity in meeting a first condition.

The first condition is that a product of the i^{th} information column quantity and the lifting size in the lifting size set is greater than or equal to the length of the information bit sequence.

For example, the i^{th} information column quantity Kᵢ may be multiplied by all lifting sizes in the lifting size set, that is, Kᵢ×Z₁, Kᵢ×Z₂, . . . , Kᵢ×Zⱼ, . . . , Kᵢ×Zⱼ, and a lifting size (for example, Zⱼ) that is greater than or equal to the length of the information bit sequence and that is a smallest value is selected. In this case, Zⱼ is a lifting size corresponding to Kᵢ. Similarly, a lifting size corresponding to each information column quantity may be obtained.

In a second possible embodiment, the j^{th} lifting size may be a smallest lifting size that is in the lifting size set and whose value is equal to

$${n}^{⌈ {log}_{n} ( \frac{K}{{K}_{i} q} ) ⌉} q .$$

The first condition is that a product of the i^{th} information column quantity and the lifting size in the lifting size set is greater than or equal to the length of the information bit sequence; n is an integer greater than or equal to 2, and K is the length of the information bit sequence; and Kᵢ is the i^{th} information column quantity in the information column quantity set, and q is a positive integer.

When the lifting size in the lifting size set may be expressed as a product of q and a power of n (as shown in the foregoing Table 1), a lifting size corresponding to Kᵢ may be determined by using the method in the second embodiment.

For example, for the i^{th} information column quantity Kᵢ, it may be determined that the lifting size corresponding to Kᵢ is

$${n}^{⌈ {log}_{n} ( \frac{K}{{K}_{i} q} ) ⌉} q .$$

Because there are one or more values of q (for example, there are n values of q, that is, q₁, q₂, . . . , qₙ), q₁ corresponds to

$${n}^{⌈ {log}_{n} ( \frac{K}{{K}_{i} {q}_{1}} ) ⌉} {q}_{1} ,$$

q₂ corresponds to

$${n}^{⌈ {log}_{n} ( \frac{K}{{K}_{i} {q}_{2}} ) ⌉} {q}_{2} , … ,$$

qₙ corresponds to

$${n}^{⌈ {log}_{n} ( \frac{K}{{K}_{i} {q}_{n}} ) ⌉} {q}_{n} ,$$

and the smallest lifting size (for example,

$${n}^{⌈ {log}_{n} ( \frac{K}{{K}_{i} {q}_{1}} ) ⌉} {q}_{1} )$$

is determined, where

$${n}^{⌈ {log}_{g} ( \frac{K}{{K}_{i} {q}_{1}} ) ⌉} {q}_{1}$$

is the lifting size corresponding to Kᵢ. Similarly, a lifting size corresponding to each information column quantity may be obtained.

In a third possible embodiment, the j^{th} lifting size may be a smallest lifting size that is in the lifting size set and whose value is equal to

$$⌈ \frac{K}{{K}_{i} q} ⌉ q .$$

The first condition is that a product of the i^{th} information column quantity and the lifting size in the lifting size set is greater than or equal to the length of the information bit sequence; n is an integer greater than or equal to 2, and K is the length of the information bit sequence; and Kᵢ is the i^{th} information column quantity in the information column quantity set, and q is a positive integer. q may be a prime number.

When lifting sizes in the lifting size set may be expressed as products of q and consecutive integers, a lifting size corresponding to Kᵢ may be determined by using the method in the third embodiment.

For example, for the i^{th} information column quantity Kᵢ, it may be determined that the lifting size corresponding to Kᵢ is

$$⌈ \frac{K}{{K}_{i} q} ⌉ q$$

Because there are one or more values of q (for example, there are n values of q, that is, q₁, q₂, . . . , qₙ), q₁ corresponds to

$$⌈ \frac{K}{{K}_{i} {q}_{1}} ⌉ {q}_{1} ,$$

q₂ corresponds to

$$⌈ \frac{K}{{K}_{i} {q}_{2}} ⌉ {q}_{2} , … ,$$

qₙ corresponds to

$$⌈ \frac{K}{{K}_{i} {q}_{n}} ⌉ {q}_{n} ,$$

and the smallest lifting size (for example,

$$⌈ \frac{K}{{K}_{i} {q}_{1}} ⌉ {q}_{1} )$$

is determined, where

$$⌈ \frac{K}{{K}_{i} {q}_{1}} ⌉ {q}_{1}$$

is the lifting size corresponding to Kᵢ. Similarly, a lifting size corresponding to each information column quantity may be obtained.

Based on this possible implementation, the lifting size corresponding to the i^{th} information column quantity may be determined by using the foregoing three methods, so that the lifting size corresponding to each information column quantity may be determined. In addition, determining, based on

$${n}^{⌈ {log}_{n} ( \frac{K}{{K}_{i} q} ) ⌉} q , or ⌈ \frac{K}{{K}_{i} q} ⌉ q ,$$

the lifting size corresponding to the i^{th} information column quantity has lower computational complexity than determining the lifting size corresponding to the i^{th} information column quantity by using the first method, thereby improving working efficiency.

In another possible implementation, an information column quantity corresponding to the j^{th} lifting size may be the i^{th} information column quantity.

In a first possible embodiment, the i^{th} information column quantity may be a smallest information column quantity that is in the information column quantity set and that supports the j^{th} lifting size in meeting a first condition.

The second condition is that a product of the j^{th} lifting size and the information column quantity in the information column quantity set is greater than or equal to the length of the information bit sequence.

For example, all information column quantities in the information column quantity set may be multiplied by the j^{th} lifting size Zⱼ, that is, K₁×Zⱼ, K₂×Zⱼ, . . . , Kᵢ×Zⱼ, . . . , K₁×Zⱼ, and an information column quantity (for example, Kᵢ) that is greater than or equal to the length of the information bit sequence and that is a smallest value is selected. In this case, Kᵢ is an information column quantity corresponding to Zⱼ. Similarly, an information column quantity corresponding to each lifting size may be obtained.

In a second possible embodiment, the i^{th} information column quantity may be an information column quantity that is in the information column quantity set and whose value is equal to

$$\frac{K}{{Z}_{j}} .$$

For example, for the j^{th} lifting size Zⱼ, it may be determined that the corresponding information column quantity is

$$\frac{K}{{Z}_{j}} .$$

### When

$$\frac{K}{{Z}_{j}}$$

is in the information column quantity set, the information column quantity corresponding to Zⱼ is

$$\frac{K}{{Z}_{j}} ;$$

$$\frac{K}{{Z}_{j}}$$

is not in the information column quantity set, there is no information column quantity corresponding to Zⱼ, and Zⱼ may be ignored in subsequent calculation. Similarly, an information column quantity corresponding to each lifting size may be obtained.

Based on this possible implementation, the information column quantity corresponding to the j^{th} lifting size may be determined by using the foregoing two methods, so that the information column quantity corresponding to each lifting size may be determined. In addition, determining, based on

$$\frac{K}{{Z}_{j}} ,$$

the information column quantity corresponding to the j^{th} lifting size has lower computational complexity than determining the information column quantity corresponding to the j^{th} lifting size by using the first method, thereby improving working efficiency.

Based on the foregoing descriptions of the X first metrics, the i^{th} information column quantity in the information column quantity set, and the j^{th} lifting size in the lifting size set, this application proposes two possible implementations for determining the target information column quantity and the target lifting size.

In a first possible implementation, the sending device determines the target information column quantity and the target lifting size based on a smallest value of the X first metrics.

For example, the x^{th} first metric is Kᵢ×Zⱼ−K. First metrics corresponding to each information column quantity and a lifting size corresponding to each information column quantity (or each lifting size and an information column quantity corresponding to each lifting size) are determined, and a smallest value (for example, the x^{th} first metric is the smallest value) is determined from the determined first metrics. An information column quantity (that is, Kᵢ) corresponding to the x^{th} first metric may be used as the target information column quantity, and a lifting size (that is, Zⱼ) corresponding to the x^{th} first metric may be used as the target lifting size.

In a second possible implementation, the sending device determines Y first metrics based on the X first metrics, and determines the target information column quantity and the target lifting size based on the Y first metrics, where a y^{th} first metric in the Y first metrics is less than or equal to a first threshold corresponding to the y^{th} first metric, Y is greater than or equal to 1, and y=1, 2, . . . , Y.

For example, Y is 1 and the x^{th} first metric is Kᵢ×Zⱼ−K. First metrics corresponding to each information column quantity and a lifting size corresponding to each information column quantity (or each lifting size and an information column quantity corresponding to each lifting size) are determined, and a first metric (for example, the x^{th} first metric) that is less than or equal to a first threshold corresponding to the first metric is determined from the determined first metrics. An information column quantity (that is, Kᵢ) corresponding to the x^{th} first metric may be used as the target information column quantity, and a lifting size (that is, Zⱼ) corresponding to the x^{th} first metric may be used as the target lifting size.

Optionally, each of the X first metrics may correspond to one first threshold, and a first threshold corresponding to the x^{th} first metric may be determined based on a lifting size corresponding to the x^{th} first metric.

For example, if the x^{th} first metric meets the following formula: Kᵢ×Zⱼ−K, the first threshold corresponding to the x^{th} first metric may be the lifting size corresponding to the x^{th} first metric.

For example, the first threshold corresponding to the x^{th} first metric may be any one of the following: Zⱼ, 2Zⱼ, 3/2Zⱼ, ½Zⱼ, ⅓Zⱼ, or ¼Zⱼ.

For another example, if the x^{th} first metric meets the following formula: (Kᵢ×Zⱼ-K)/Zⱼ, the first threshold corresponding to the x^{th} first metric may be any one of the following: 1, 2, 3/2, ½, ⅓, or ¼.

Based on the foregoing two examples, optional values of the first threshold corresponding to the first metric are proposed, so that more feasible solutions are provided for determining the first threshold corresponding to the first metric, and the first threshold corresponding to the first metric may be determined based on an actual communication status, thereby improving working efficiency and improving flexibility in determining the first threshold.

Based on the foregoing two possible implementations, the sending device may determine the target information column quantity and the target lifting size based on the smallest value, so that a difference between the length of the information bit sequence and a product of the target information column quantity and the target lifting size is minimized. In this way, degree distribution of the base graph and integrity of the base graph can be protected. Alternatively, the sending device determines the target information column quantity and the target lifting size based on the Y first metrics, so that more feasible solutions may be provided for determining the target information column quantity and the target lifting size, and the corresponding target information column quantity and the target lifting size may be determined based on an actual communication status, thereby improving flexibility in determining the target information column quantity and the target lifting size. In this way, degree distribution of the base graph and integrity of the base graph can be protected for different communication requirements, and decoding performance can be improved.
S603: The sending device encodes the information bit sequence based on the target information column quantity and the target lifting size, to obtain an encoded bit sequence.

In this embodiment of this application, two possible implementations are proposed based on encoding of the information bit sequence.

In a first possible implementation, the sending device may determine information columns of the base graph based on the target information column quantity. For example, when the target information column quantity is 10, it may be determined that the first ten columns of the base graph are target information columns (that is, information columns other than the first ten columns in the base graph are removed), and the information bit sequence is encoded based on the ten target information columns.

In a second possible implementation, the sending device may determine, based on the target information column quantity and an indication sequence, target information columns from the base graph corresponding to the information bit sequence, and then encode the information bit sequence.

Optionally, the indication sequence may be determined based on the length and the code rate of the information bit sequence; or the indication sequence may be determined based on first indication information, where the first indication information indicates a communication scenario.

For example, the indication sequence may be {1, 2, 14, 5, 6, 7, 9, 8, 10, 11, 17, 19, 13, 3, 19, 16, 17, 19, 19, 21, 22, 4}, or the indication sequence may be {1, 2, 5, 6, 7, 9, 8, 10, 3, 4}. This is not limited.

Optionally, the indication sequence may be determined based on the length and the code rate of the information bit sequence.

For example, when the length of the information bit sequence is less than or equal to 292, the indication sequence is {1, 2, 5, 6, 7, 9, 8, 10, 3, 4}; or when the length of the information bit sequence is less than or equal to 3824 and the code rate is less than or equal to 0.67, the indication sequence may be {1, 2, 5, 6, 7, 9, 8, 10, 3, 4}; or when the length of the information bit sequence is greater than 3824, the indication sequence is {1, 2, 14, 5, 6, 7, 9, 8, 10, 11, 17, 19, 13, 3, 19, 16, 17, 19, 19, 21, 22, 4}.

It may be understood that the indication sequence may be determined based on the length and the code rate of the information bit sequence, or may be determined based on a communication scenario. The indication sequence may be determined based on an actual communication status, to meet different communication requirements.

Optionally, a length of the indication sequence is a maximum information column quantity corresponding to the base graph.

For example, when the maximum information column quantity corresponding to the base graph is 22, a quantity of elements in the indication sequence is 22 (that is, the length of the indication sequence is 22).

Optionally, elements of the indication sequence correspond to columns of the base graph.

For example, the indication sequence is {1, 2, 5, 6, 7, 9, 8, 10, 3, 4}. 1 in the indication sequence corresponds to the first column of the base graph, 2 in the indication sequence corresponds to the second column of the base graph, 5 in the indication sequence corresponds to the fifth column of the base graph, . . . , 4 in the indication sequence corresponds to the fourth column of the base graph.

It may be understood that the elements of the indication sequence correspond to the columns of the base graph, and that an order of the information columns of the base graph may be changed when the target information columns are being determined, thereby improving encoding performance.

In a possible embodiment, first T elements of the indication sequence may be determined based on the target information column quantity T; and information columns that are in the base graph and that correspond to the first T elements are determined as one or more target information columns, where T is a positive integer.

For example, T is 10 and the indication sequence is {1, 2, 14, 5, 6, 7, 9, 8, 10, 11, 17, 19, 13, 3, 19, 16, 17, 19, 19, 21, 22, 4}. The first 10 elements in the indication sequence, that is, {1, 2, 14, 5, 6, 7, 9, 8, 10, 11}, may be taken based on T, and information columns corresponding to {1, 2, 14, 5, 6, 7, 9, 8, 10, 11} in the base graph may be determined as target information columns.

For example, 1 corresponds to the first information column of the base graph, 2 corresponds to the second information column of the base graph, 14 corresponds to the fourteenth information column of the base graph, and so on, and 11 corresponds to the eleventh information column of the base graph. The ten information columns of the base graph may be determined as the target information columns.

For another example, T is 6, and the information column quantity set corresponding to the base graph is {0, 1, 2, 5, 6, 8, 9, 4, 3, 7}. First six elements of the indication sequence, that is, {0, 1, 2, 5, 6, 8}, may be taken based on T, and in the base graph, information columns corresponding to {0, 1, 2, 5, 6, 8} may be determined as the target information columns.

For example, 0 corresponds to the first information column of the base graph, 1 corresponds to the second information column of the base graph, 2 corresponds to the third information column of the base graph, 5 corresponds to the sixth information column of the base graph, 6 corresponds to the seventh information column of the base graph, and 8 corresponds to the ninth information column of the base graph. The six information columns of the base graph may be determined as the target information columns.
S604: The sending device sends the encoded bit sequence to the receiving device; and correspondingly, the receiving device receives to-be-decoded information from the sending device.

The sending device may map the encoded bit sequence to frequency domain or time domain, to form a signal, and send the signal to the receiving device; and correspondingly, the receiving device may obtain the to-be-decoded information in the signal based on the received signal.
S605: The receiving device decodes the to-be-decoded information based on the target information column quantity and the target lifting size, to obtain a decoded information bit sequence.

The target information column quantity and the target lifting size are determined by comparing the X first metrics, the x^{th} first metric in the X first metrics is determined based on the length of the information bit sequence, the i^{th} information column quantity in the information column quantity set, and the j^{th} lifting size in the lifting size set, and the i^{th} information column quantity corresponds to the j^{th} lifting size; X is greater than or equal to 2; x=1, 2, . . . , X; and the information column quantity set and the lifting size set are associated with the base graph corresponding to the information bit sequence.

Determining, by the receiving device, the target information column quantity and the target lifting size is consistent with determining, by the sending device, the target information column quantity and the target lifting size. Details are not described herein again.

It should be noted that the to-be-decoded information may carry information indicating the length of the information bit sequence, and the receiving device may determine, based on the indication information, the length of the information bit sequence corresponding to the to-be-decoded information; or the sending device may send, to the receiving device, control information that carries the length of the information bit sequence, and the receiving device may determine, based on the control information, the length of the information bit sequence corresponding to the to-be-decoded information. This is not limited.

It may be understood that a method for determining the target information column quantity and the target lifting size by the receiving device is consistent with the method for determining the target information column quantity and the target lifting size by the sending device in S602. Details are not described herein again.

Based on the sequence transmission method in FIG. 6, unlike a sending device that determines a target information column quantity based on a length of an information bit sequence and then determines a target lifting size based on the target information column quantity, the sending device in this application may determine the target information column quantity and the target lifting size by comparing the X first metrics. On one hand, more feasible solutions may be provided for determining the target information column quantity and the target lifting size. On the other hand, the difference between the length of the information bit sequence and the product of the target information column quantity and the target lifting size may not increase as the length of the bit sequence increases, and the difference may be relatively small or remain within a specific range. In this way, degree distribution of the base graph and integrity of the base graph can be protected, and decoding performance can be improved.

Based on S602 in FIG. 6, the x^{th} first metric in the X first metrics may be further determined based on the length of the information bit sequence, the i^{th} information column quantity in the first information column quantity set, and the j^{th} lifting size in the first lifting size set.

The first information column quantity set is one or more candidate information column quantities determined from the information column quantity set, the first lifting size set is one or more candidate lifting sizes determined from the lifting size set, X is greater than or equal to 2, and x=1, 2, . . . , X.

The first information column quantity set may include P information column quantities, where 1≤i≤P; and the second lifting size set may include Q lifting sizes, where 1≤j≤Q.

It should be noted that P may be equal to I, or may be unequal to I; and Q may be equal to J, or may be unequal to J.

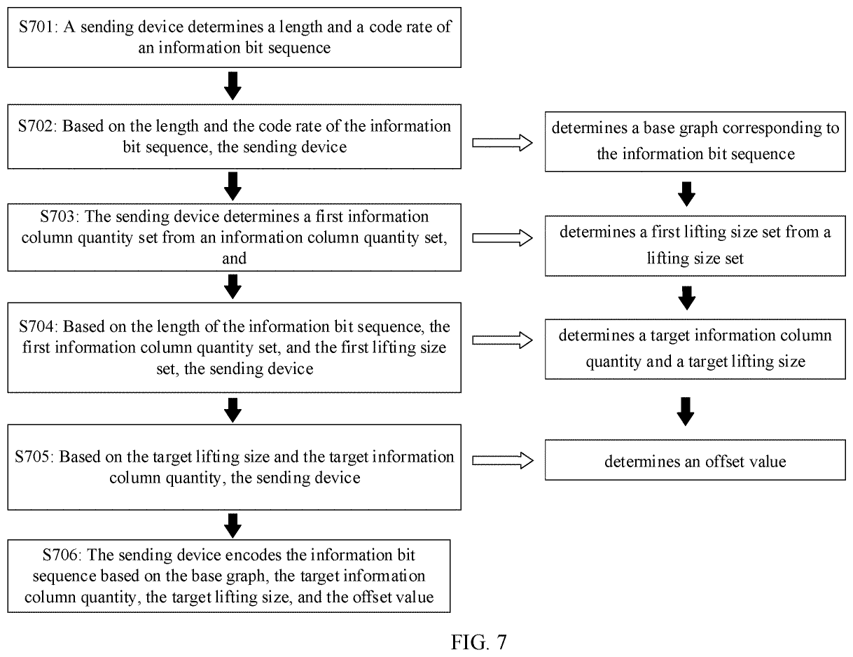

It may be understood that the sending device may alternatively determine the target information column quantity and the target lifting size based on the first information column quantity set and the first lifting size set and then encode the information bit sequence. Specific steps may be shown in FIG. 7.
S701: A sending device determines a length and a code rate of an information bit sequence.
S702: The sending device determines, based on the length and the code rate of the information bit sequence, a base graph corresponding to the information bit sequence.

A method for determining the base graph corresponding to the information bit sequence is consistent with the method in S601, and details are not described herein again.

Optionally, the sending device may determine, based on the base graph corresponding to the information bit sequence, an information column quantity set and a lifting size set that are associated with the base graph corresponding to the information bit sequence.
S703: The sending device determines a first information column quantity set from the information column quantity set, and determines a first lifting size set from the lifting size set.

The first information column quantity set may include P information column quantities, where 1≤i≤P; and the second lifting size set may include Q lifting sizes, where 1≤j≤Q.

Based on S703, this application provides several possible embodiments for determining the first information column quantity set (one or more candidate information column quantities) and the first lifting size set (one or more candidate lifting sizes).

In a first possible embodiment, the sending device may determine one or more candidate information column quantities and one or more candidate lifting sizes from the information column quantity set and the lifting size set based on the length of the information bit sequence.

For example, a first code length interval corresponds to a subset 11 in the information column quantity set, and the first code length interval corresponds to a subset 12 in the lifting size set. When the length of the information bit sequence is within the first code length interval, an information column quantity in the subset 11 may be one or more candidate information column quantities, and a lifting size in the subset 12 may be one or more candidate lifting sizes.

In a second possible embodiment, the sending device may determine one or more candidate information column quantities and one or more candidate lifting sizes from the information column quantity set and the lifting size set based on the length and the code rate of the information bit sequence.

For example, a first code length interval and a first code rate interval correspond to a subset 21 in the information column quantity set, and the first code length interval and the first code rate interval correspond to a subset 22 in the lifting size set. When the length of the information bit sequence is within the first code length interval and the code rate of the information bit sequence is within the first code rate interval, an information column quantity in the subset 21 may be one or more candidate information column quantities, and a lifting size in the subset 22 may be one or more candidate lifting sizes.

In a third possible embodiment, the sending device may determine one or more candidate information column quantities and one or more candidate lifting sizes from the information column quantity set and the lifting size set based on the code rate of the information bit sequence.

For example, a first code rate interval corresponds to a subset 31 in the information column quantity set, and the first code rate interval corresponds to a subset 32 in the information column quantity set. When the code rate of the information bit sequence is within the first code rate interval, an information column quantity in the subset 31 may be one or more candidate information column quantities, and a lifting size in the subset 32 may be one or more candidate lifting sizes.

In a fourth possible embodiment, the sending device may determine one or more candidate information column quantities and one or more candidate lifting sizes from the information column quantity set and the lifting size set based on first indication information, where the first indication information indicates a communication scenario.

For example, a first scenario corresponds to a subset 41 in the information column quantity set, and the first scenario corresponds to a subset 42 in the lifting size set. When the first indication information indicates a scenario 1, an information column quantity in the subset 41 may be one or more candidate information column quantities, and a lifting size in the subset 42 may be one or more candidate lifting sizes.

Based on the foregoing description of determining the second information column quantity set, this application proposes two possible implementations for different scenarios.

In a possible implementation, for a high throughput scenario, the second information column quantity set may be determined by using the method in this application. The second information column quantity set is characterized in that as the code rate of the information bit sequence increases, a quantity of elements gradually decreases and a smallest value in the second information column quantity set gradually increases.

For example, when the code rate of the information bit sequence is within a range of 0.85 to 0.917, the second information column quantity set may be {22, 24, 26}. When the code rate of the information bit sequence is within a range of 0.917 to 0.926, the second information column quantity set is {24, 26}. When the code rate of the information bit sequence is greater than 0.926, the second information column quantity set includes only 26. This solution can prevent the code rate from being excessively high in the high throughput scenario, and can avoid, as much as possible, occurrence of a relatively small value of a candidate information column quantity, which may otherwise lead to an incomplete core matrix and cause poor decoding performance.

In another possible implementation, for a URLLC scenario, the second information column quantity set is determined by using the method in this application. The second information column quantity set is characterized in that as the code rate of the information bit sequence decreases, a quantity of elements decreases, and a largest value in the second information column quantity set gradually decreases.

For example, when the code rate of the information bit sequence is within a range of ½ to ⅖, the second information column quantity set is {10, 9, 8, 6}. When the code rate of the information bit sequence is within a range of ⅖ to ⅓, the second information column quantity set is {9, 8, 6}. When the code rate of the information bit sequence is within a range of ⅓ to ⅕, the second information column quantity set is {8, 6}. When the code rate of the information bit sequence is less than ⅕, the second information column quantity set includes only 6. This solution can support a requirement for a low code rate and a low latency, and avoid, as much as possible, occurrence of a relatively large value of a candidate information column quantity, which may otherwise lead to a relatively large base graph size and relatively high complexity.

S704: The sending device determines a target information column quantity and a target lifting size based on the length of the information bit sequence, the first information column quantity set, and the first lifting size set.

The target information column quantity and the target lifting size are determined by comparing X first metrics.

An x^{th} first metric in the X first metrics is determined based on the length of the information bit sequence, an i^{th} information column quantity in the information column quantity set, and a j^{th} lifting size in the lifting size set.

It may be understood that determining the target information column quantity and the target lifting size by comparing the X first metrics in S704 is consistent with determining the target information column quantity and the target lifting size by comparing the X first metrics in S602. Details are not described herein again.
S705: The sending device determines an offset value based on the target lifting size and the target information column quantity.

The offset value is an offset factor in a decoding algorithm, so that encoding performance approaches a Shannon limit, and decoding performance can be improved.
S706: The sending device encodes the information bit sequence based on the base graph, the target information column quantity, the target lifting size, and the offset value.

A method for encoding the information bit sequence in S706 is consistent with the method for encoding the information bit sequence in S603. Details are not described herein again.

Based on the method shown in FIG. 7, the second information column quantity set and the second lifting size set are determined, so that a range for determining the target information column quantity and the target lifting size can be narrowed, thereby reducing computational complexity and improving working efficiency.

Based on S602 in FIG. 6, when the sending device determines the smallest value of the X first metrics, there may be one smallest value (an information column quantity and a lifting size that correspond to the smallest value are directly used as the target information column quantity and the target lifting size), or there may be at least two smallest values. This application provides several possible embodiments.

In a first possible embodiment, when there are at least two smallest values, a largest or smallest one of at least two information column quantities corresponding to the at least two smallest values is determined as the target information column quantity, and a lifting size corresponding to the target information column quantity is determined as the target lifting size.

For example, there are two smallest values, and information column quantities corresponding to the two smallest values are Kᵢ and Kᵢ respectively, where Kᵢ>Kⱼ. Kᵢ may be determined as the target information column quantity, and a lifting size corresponding to Kᵢ may be determined as the target lifting size; or Kᵢ may be determined as the target information column quantity, and a lifting size corresponding to Kᵢ may be determined as the target lifting size.

In a second possible embodiment, when there are at least two smallest values, a largest or smallest one of at least two lifting sizes corresponding to the at least two smallest values is determined as the target lifting size, and an information column quantity corresponding to the target lifting size is determined as the target information column quantity.

For example, there are two smallest values, and lifting sizes corresponding to the two smallest values are Zᵢ and Zⱼ respectively, where Zᵢ>Zⱼ. Zᵢ may be determined as the target lifting size, and an information column quantity corresponding to Zᵢ may be determined as the target information column quantity; or Zⱼ may be determined as the target lifting size, and an information column quantity corresponding to Zⱼ may be determined as the target information column quantity.

In a third possible embodiment, when there are at least two smallest values, the target information column quantity is determined, based on first indication information, from at least two information column quantities corresponding to the at least two smallest values, and a lifting size corresponding to the target information column quantity is determined as the target lifting size, where the first indication information indicates a communication scenario.

For example, there are two smallest values, and information column quantities corresponding to the two smallest values are Kᵢ and Kᵢ respectively, where Kᵢ>Kⱼ. In a high throughput scenario, Kᵢ may be determined as the target information column quantity, so that the code rate can be prevented from being excessively high in the high throughput scenario. In addition, a lifting size corresponding to Kᵢ may be determined as the target lifting size. Alternatively, in a URLLC scenario, Kᵢ may be determined as the target information column quantity, so that a requirement for a low code rate and a low latency in the URLLC scenario can be met. In addition, a lifting size corresponding to Kⱼ may be determined as the target lifting size.

In a fourth possible embodiment, when there are at least two smallest values, the target lifting size is determined, based on first metric information, from at least two lifting sizes corresponding to the at least two smallest values, and an information column quantity corresponding to the target lifting size is determined as the target information column quantity, where the first indication information indicates a communication scenario.

For example, there are two smallest values, and lifting sizes corresponding to the two smallest values are Zᵢ and Zⱼ respectively, where Zᵢ>Zⱼ. In a high throughput scenario, Zᵢ may be determined as the target lifting size, so that the code rate can be prevented from being excessively high in the high throughput scenario. In addition, an information column quantity corresponding to Zᵢ may be determined as the target information column quantity. Alternatively, in a URLLC scenario, Zⱼ may be determined as the target lifting size, so that a requirement for a low code rate and a low latency in the URLLC scenario can be met. In addition, an information column quantity corresponding to Zⱼ may be determined as the target information column quantity.

Based on the foregoing several possible embodiments, when there are at least two smallest values, the target information column quantity and the target lifting size may be determined according to the foregoing several methods, and the target information column quantity and the target lifting size may be determined based on different communication requirements, so that the target information column quantity and the target lifting size can be determined more flexibly, thereby providing a plurality of feasible solutions for determining the target information column quantity and the target lifting size. In this way, degree distribution of the base graph and integrity of the base graph can be protected for different communication requirements, and decoding performance can be improved.

Based on S602 in FIG. 6, when the sending device determines the Y first metrics, where Y may be 1 (an information column quantity and a lifting size that correspond to the first metric are directly used as the target information column quantity and the target lifting size), or Y may be greater than 1, this application provides several possible embodiments.

In a first possible embodiment, when Y is greater than 1, a largest or smallest one of Y information column quantities corresponding to the Y first metrics is determined as the target information column quantity, and a lifting size corresponding to the target information column quantity is determined as the target lifting size.

For example, Y is equal to 2, and information column quantities corresponding to the two first metrics are Kᵢ and Kⱼ respectively, where Kᵢ>Kⱼ. Kᵢ may be determined as the target information column quantity, and a lifting size corresponding to Kᵢ may be determined as the target lifting size; or Kᵢ may be determined as the target information column quantity, and a lifting size corresponding to Kᵢ may be determined as the target lifting size.

In a second possible embodiment, when Y is greater than 1, a largest or smallest lifting size of Y information column quantities corresponding to the Y first metrics is determined as the target lifting size, and an information column quantity corresponding to the target lifting size is determined as the target information column quantity.

For example, Y is equal to 2, and lifting sizes corresponding to the two first metrics are Zᵢ and Zⱼ respectively, where Zᵢ>Zⱼ. Zᵢ may be determined as the target lifting size, and an information column quantity corresponding to Zᵢ may be determined as the target information column quantity; or Zⱼ may be determined as the target lifting size, and an information column quantity corresponding to Z; may be determined as the target information column quantity.

In a third possible embodiment, when Y is greater than 1, the target information column quantity is determined, based on first indication information, from Y information column quantities corresponding to the Y first metrics, and a lifting size corresponding to the target information column quantity is determined as the target lifting size, where the first indication information indicates a communication scenario.

For example, Y is equal to 2, and information column quantities corresponding to the two first metrics are Kᵢ and Kᵢ respectively, where Kᵢ>Kⱼ. In a high throughput scenario, Kᵢ may be determined as the target information column quantity, so that the code rate can be prevented from being excessively high in the high throughput scenario. In addition, a lifting size corresponding to Kᵢ may be determined as the target lifting size. Alternatively, in a URLLC scenario, Kᵢ may be determined as the target information column quantity, so that a requirement for a low code rate and a low latency in the URLLC scenario can be met. In addition, a lifting size corresponding to Kⱼ may be determined as the target lifting size.

In a fourth possible embodiment, when Y is greater than 1, the target lifting size is determined, based on first indication information, from Y lifting sizes corresponding to the Y first metrics, and an information column quantity corresponding to the target lifting size is determined as the target information column quantity, where the first indication information indicates a communication scenario.

For example, Y is equal to 2, and lifting sizes corresponding to the two first metrics are Zᵢ and Zⱼ respectively, where Zᵢ>Zⱼ. In a high throughput scenario, Zᵢ may be determined as the target lifting size, so that the code rate can be prevented from being excessively high in the high throughput scenario. In addition, an information column quantity corresponding to Zᵢ may be determined as the target information column quantity. Alternatively, in a URLLC scenario, Zⱼ may be determined as the target lifting size, so that a requirement for a low code rate and a low latency in the URLLC scenario can be met. In addition, an information column quantity corresponding to Z; may be determined as the target information column quantity.

Based on the foregoing several possible embodiments, when Y is greater than 1, the target information column quantity and the target lifting size may be determined based on different communication requirements, so that the target information column quantity and the target lifting size can be determined more flexibly, thereby providing a plurality of feasible solutions for determining the target information column quantity and the target lifting size. In this way, degree distribution of the base graph and integrity of the base graph can be protected for different communication requirements, and decoding performance can be improved.

Based on S603 in FIG. 6, after determining the target information column quantity and the target lifting size, the sending device may indicate a to-be-encoded sequence according to the following program:

```
s = 0 ;
for r = 0 to C − 1
  for k = 0 to K′−L−1
    cᵣₖ = bₛ ;
    s = s + 1 ;
  end for
  if C > 1
```

The sequence cᵣ₀, cᵣ₁, cᵣ₂, cᵣ₃, . . . , c_{r(K′-L-1)} is used to calculate cyclic redundancy check (CRC) parity bits according to a generator polynomial g_{CRC24B} (D) (The sequence cᵣ₀, cᵣ₁, cᵣ₂, cᵣ₃, . . . , c_{r(K′-L-1)} is used to calculate the CRC parity bits pᵣ₀, pᵣ₁, pᵣ₂, . . . , p_{r(L-1)} according to generator polynomial g_{CRC24B} (D)

```
    for k = K′−L to K′−1
      cᵣₖ = p_{r(k+L-K′)};
    end for
  end if
  for k = K′ to K−1 -- Insertion of filler bits (Insertion of filler bits)
    cᵣₖ =< NULL > --NULL: null
  end for
end for
```

C is a quantity of code blocks (CBs), cᵣₖ is a kth bit of an r^{th} CB, bs is an s^{th} bit of the information bit sequence, the length of the information bit sequence is K′, and pᵣ is a CRC added to the r^{th} CB.

K=kb*Zc, where kb is the target information column quantity, Zc is the target lifting size, and K is the length of the information bit sequence.

Understandably, in each CB, first K′−L bits are the information bit sequence, bits from a (K′−L)^{th} bit to a (K′−1)^{th} bit are the CRC, and last K−K′ bits are filler bits (that is, NULL), that is, last positions in the base graph are filler bits.

for k = K′ to K−1 -- Insertion of filler bits
cᵣₖ =< NULL >
end for

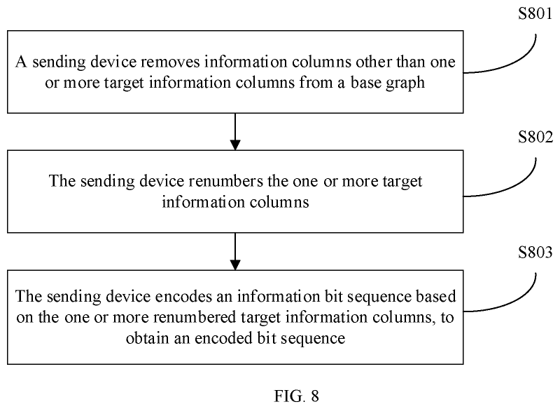

Based on S603 in FIG. 6, after determining the target information column quantity and the indication sequence, the sending device may renumber the information columns and then encode the information bit sequence by using a method shown in FIG. 8. Specific steps are as follows.
S801: A sending device removes information columns other than one or more target information columns from a base graph.

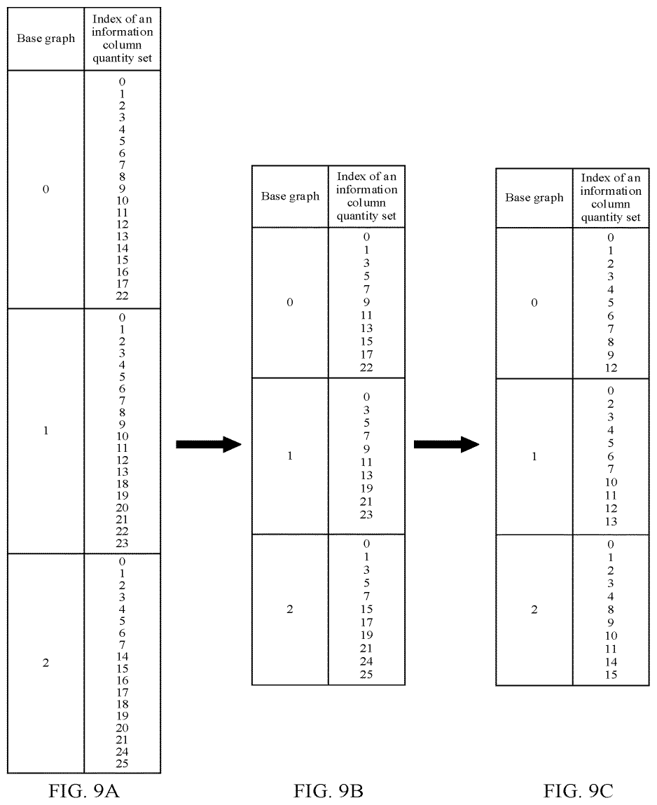

For example, as shown in the following FIG. 9A to FIG. 9C, FIG. 9A represents an index of an information column quantity set corresponding to the base graph. Unused information columns (that is, information columns other than the target information column) in the first column may be marked based on the target information column quantity, and the unused information columns are removed. FIG. 9B represents an index of an information column quantity set corresponding to the base graph after the unused information columns are removed.

For example, the information column quantity set corresponding to the base graph is {0, 1, 2, 3, 4, 5, 6, 7, 8, 9, 10, 11, 12, 13, 14, 15, 16, 17, 22}, and the unused information columns are marked (for example, an information column quantity set corresponding to the unused information columns is {2, 4, 6, 8, 10, 12, 14, 16}). In this case, an information column quantity set obtained after the unused information columns are removed is {0, 1, 3, 5, 7, 9, 11, 13, 15, 17, 22}.
S802: The sending device renumbers the one or more target information columns.

Optionally, looping may be performed on the one or more target information columns to renumber the one or more target information columns.

For example, as shown in FIG. 9A to FIG. 9C, after the index of the information column quantity set corresponding to the base graph in FIG. 9B is renumbered, the index of the information column quantity set corresponding to the base graph in FIG. 9C may be obtained.

For example, the information column quantity set corresponding to the base graph in the second column is {0, 1, 3, 5, 7, 9, 11, 13, 15, 17, 22}. After the information columns are renumbered, a numbered information column quantity set {0, 1, 2, 3, 4, 5, 6, 7, 8, 9, 12} may be obtained.

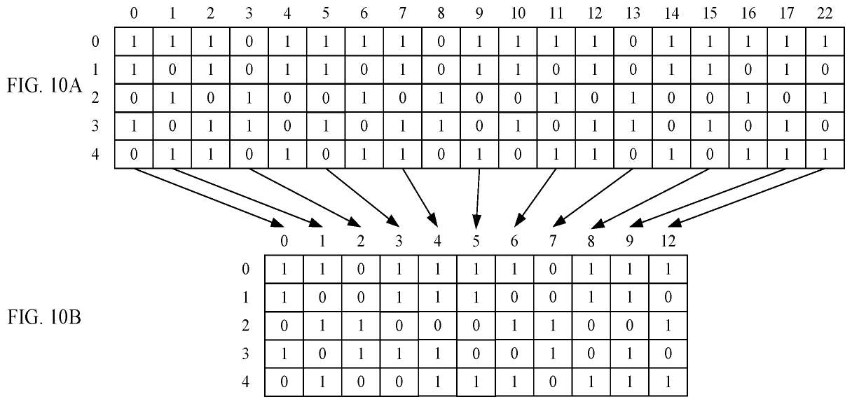

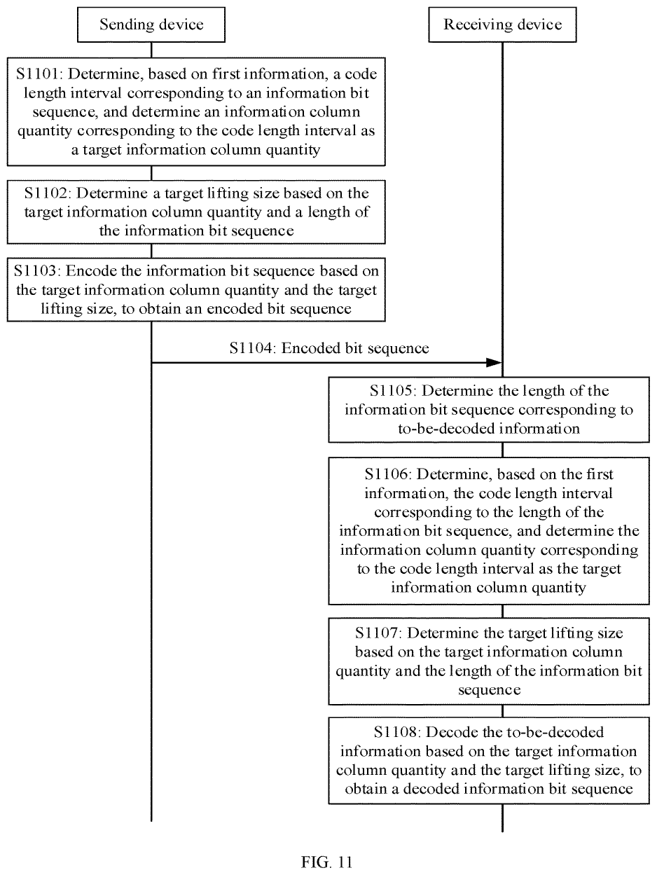

A numbering rule may be shown in FIG. 10A and FIG. 10B, where a vertical direction represents an edge of the base graph, and a horizontal direction represents the index of the information column quantity set corresponding to the base graph. FIG. 10A represents the base graph in which no information column is removed, and FIG. 10B represents the base graph obtained after information columns are removed and renumbering is performed.
S803: The sending device encodes an information bit sequence based on the one or more renumbered target information columns, to obtain an encoded bit sequence.

Based on the method in FIG. 8, after determining the target information column quantity and a target lifting size, the sending device may indicate the to-be-encoded sequence according to the following program:

```
  s = 0 ;
  for r = 0 to C − 1
```

| | |
|---|---|
| for t =0 to kb − 1 | --New looping manner, where looping is performed on |

columns of the base graph rather than on bits
for k = T(t) to min (T(t) + Zc − 1, K′)

| | |
|---|---|
| if t ∈ T(kb) | --Used information column |

```
            cᵣₖ = bs;
            s = s + 1;
```

| | |
|---|---|
| else | -- Unused information column |

```
            cᵣₖ =< Null >
          end for
    end for
    if C > 1
```

The sequence cᵣ₀, cᵣ₁, cᵣ₂, cᵣ₃, . . . , c_{r(K′-L-1)} is used to calculate CRC parity bits according to a generator polynomial g_{CRC24B} (D) (The sequence cᵣ₀, cᵣ₁, cᵣ₂, cᵣ₃, . . . , c_{r(K′-L-1)} is used to calculate the CRC parity bits pᵣ₀, pᵣ₁, pᵣ₂, . . . , p_{r(L-1)} according to generator polynomial g_{CRC24B} (D).)

```
    for k = K′−L to K′−1
      cᵣₖ = p_{r(k+L-K′)};
    end for
  end if
  for k = K′ to K−1 --Insertion of filler bits
    cᵣₖ =< NULL >
  end for
end for
```

T (t) represents an information column quantity. When the information column quantity is the target information column quantity, the information bit sequence or the CRC may be placed on a CB corresponding to the column; otherwise, the CB corresponding to the column is filled with bits.

It can be learned by comparing the code in the foregoing two possible implementations that, in the second possible implementation, looping on the target information column is added, and looping is performed on the information bit sequence within the column. Therefore, filler bits are not only distributed at last positions, but also may be distributed at intermediate positions. In this way, degree distribution of the base graph and integrity of the base graph can be protected, and decoding performance can be improved.

Optionally, this application further proposes a sequence transmission method, to explicitly determine a target information column quantity and reduce computational complexity. As shown in FIG. 11, specific steps are as follows.
S1101: A sending device determines, based on first information, a code length interval corresponding to an information bit sequence, and determines an information column quantity corresponding to the code length interval as a target information column quantity.

The first information in S1101 indicates an information column quantity corresponding to each of a plurality of code length intervals.

For example, the sending device may divide a code length interval (for example, (a₁, b₁), (a₂, b₂), . . . , (aₖ, bₖ)) based on a length of a supported information bit sequence. An information column quantity corresponding to (a₁, b₁) may be K₁, an information column quantity corresponding to (a₂, b₂) may be K₂, . . . , an information column quantity corresponding to (aₖ, bₖ) may be Kk.

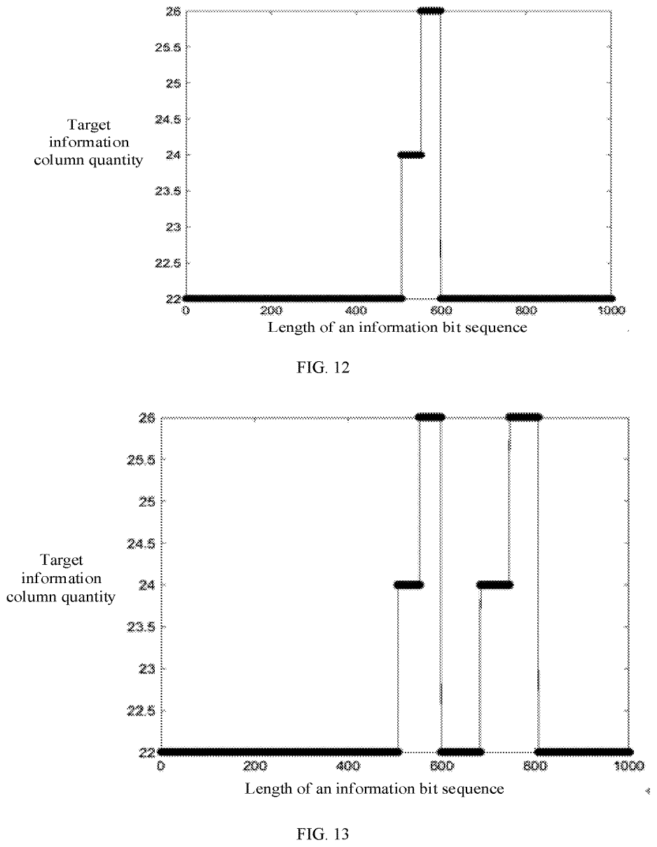

For example, as shown in FIG. 12, an information column quantity corresponding to a first code length interval (500, 570) is 24, an information column quantity corresponding to a second code length interval (571, 600) is 26, and an information column quantity corresponding to a third code length interval is 22, where the third code length interval is a code length interval less than the first code length interval and greater than the second code length interval.

For another example, as shown in FIG. 13, an information column quantity corresponding to first code length intervals (500, 570) and (700, 770) is 24, an information column quantity corresponding to second code length intervals (571, 600) and (771, 800) is 26, and an information column quantity corresponding to a third code length interval is 22, where the third code length interval is a code length interval other than the first code length intervals and the second code length intervals.

For another example, an information column quantity corresponding to first code length intervals (703, 728) and (781, 832) is 8, an information column quantity corresponding to second code length intervals (625, 650) and (875, 910) is 10, and an information column quantity corresponding to a third code length interval is 6, where the third code length interval is a code length interval other than the first code length intervals and the second code length intervals.

The code length interval and the information column quantity corresponding to the code length interval are determined, so that the target information column quantity can be explicitly determined based on the code length interval corresponding to a length of the information bit sequence, thereby reducing computational complexity and improving working efficiency.

The code length interval in S1101 and the information column quantity corresponding to each code length interval are determined by comparing A first metrics.

A is greater than or equal to 2, an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size.

a=1, 2, . . . , A; the information column quantity set and the lifting size set are associated with a base graph corresponding to the length value; and the code length interval includes B length values, and 1≤b≤B.

It may be understood that a method for determining the information column quantity set and the lifting size set based on the length value is consistent with the foregoing method for determining the information column quantity set and the lifting size set based on the length of the information bit sequence. Details are not described herein again.

Optionally, the code length interval and the information column quantity corresponding to each code length interval are determined based on an information column quantity corresponding to each length value.

For example, each length value may be traversed starting from a length value of 1, and a target information column quantity corresponding to each length value is determined accordingly. A code length interval may be determined based on equal values of target information column quantities, and then an information column quantity corresponding to the code length interval may be determined.

Optionally, the a^{th} first metric is a difference between a first product and the b^{th} length value; or the a^{th} first metric is a ratio of a first difference to the j^{th} lifting size. This is not limited.

The first product is a product of the i^{th} information column quantity and the j^{th} lifting size, and the first difference is the difference between the first product and the b^{th} length value.

For example, when the a^{th} first metric is the difference between the first product and the b^{th} length value, the a^{th} first metric may be expressed by using the following formula: Kᵢ×Zⱼ−K.

Kᵢ is the i^{th} information column quantity in the information column quantity set, Zⱼ is the j^{th} lifting size in the lifting size set, and K is the b^{th} length value.

For another example, when the a^{th} first metric is the ratio of the first difference to the j^{th} lifting size, the a^{th} first metric may be expressed by using the following formula: (Kᵢ×Zⱼ−K)/Zᵢ=Kᵢ−K/Zⱼ.

Kᵢ is the i^{th} information column quantity in the information column quantity set, Zⱼ is the j^{th} lifting size in the lifting size set, and K is the b^{th} length value.

It may be understood that Kᵢ may be used as an information column quantity corresponding to Zⱼ, and correspondingly, Z; may be used as a lifting size corresponding to Kᵢ, that is, the i^{th} information column quantity corresponds to the j^{th} lifting size. A method for determining Kᵢ and Zⱼ is consistent with the method for determining Kᵢ and Z; in S602. Details are not described herein again.

Optionally, as shown in FIG. 7, the sending device may further determine one or more candidate information column quantities and one or more candidate lifting sizes from the information column quantity set and the lifting size set that are associated with the base graph, and may determine, based on the one or more candidate information column quantities and the one or more candidate lifting sizes, the information column quantity corresponding to each length value. This can reduce computational complexity and improve working efficiency. Specific steps are not described again.

Based on the foregoing descriptions of the A first metrics, the i^{th} information column quantity in the information column quantity set, and the j^{th} lifting size in the lifting size set, this application proposes two possible implementations for determining the information column quantity corresponding to each length value.

In a first possible implementation, the information column quantity corresponding to each length value is determined based on a smallest value of C first metrics, where

C is greater than or equal to 1.

It should be noted that a method for determining, based on the smallest value, the information column quantity corresponding to each length value is consistent with the method for determining the target information column quantity based on the smallest value in S602. Details are not described herein again.

In a second possible implementation, H first metrics are determined based on C first metrics, and the information column quantity corresponding to each length value is determined based on the H first metrics, where

C is greater than or equal to 1, an h^{th} first metric in the H first metrics is less than or equal to a first threshold corresponding to the h^{th} first metric, H is greater than or equal to 1, and h=1, 2, . . . , H.

It should be noted that a method for determining, by using the first threshold, the information column quantity corresponding to each length value is consistent with the method for determining the target information column quantity by using the first threshold in S602. Details are not described herein again.

Based on the foregoing two possible implementations, the target information column quantity and a target lifting size are determined based on the smallest value, so that a difference between the length value and a product of the target information column quantity and the target lifting size can be minimized. In this way, degree distribution of the base graph and integrity of the base graph can be protected, and decoding performance can be improved. In addition, the target information column quantity and the target lifting size are determined based on the H first metrics, so that more feasible solutions can be provided for determining the target information column quantity and the target lifting size, and the information column quantity corresponding to each length value can be determined based on an actual communication status, thereby improving flexibility in determining the information column quantity corresponding to each length value. In this way, degree distribution of the base graph and integrity of the base graph can be protected, and decoding performance can be improved.

S1102: The sending device determines the target lifting size based on the target information column quantity and the length of the information bit sequence.

Optionally, the sending device may determine, according to the method in S1101, the information column quantity and the lifting size corresponding to the information column quantity. Therefore, after determining the target information column quantity, the sending device may determine the lifting size corresponding to the target information column quantity as the target lifting size.

Based on S1102, after the target information column quantity is determined, the target lifting size may be determined based on the lifting size corresponding to the target information column quantity, and it may be ensured that a difference between the length of the information bit sequence and the product of the target information column quantity and the target lifting size is relatively small. In this way, degree distribution of the base graph and integrity of the base graph can be protected, and decoding performance can be improved.

S1103: The sending device encodes the information bit sequence based on the target information column quantity and the target lifting size, to obtain an encoded bit sequence.

A method for encoding the information bit sequence by the sending device is consistent with the method in S603. Details are not described herein again.

S1104: The sending device sends the encoded bit sequence to a receiving device; and correspondingly, the receiving device receives to-be-decoded information from the sending device.

The sending device may map the encoded bit sequence to frequency domain or time domain, to form a signal, and send the signal to the receiving device; and correspondingly, the receiving device may obtain the to-be-decoded information in the signal based on the received signal.

S1105: The receiving device determines the length of the information bit sequence corresponding to the to-be-decoded information.

The to-be-decoded information may carry information indicating the length of the information bit sequence, and the receiving device may determine, based on the indication information, the length of the information bit sequence corresponding to the to-be-decoded information; or the sending device may send, to the receiving device, control information that carries the length of the information bit sequence, and the receiving device may determine, based on the control information, the length of the information bit sequence corresponding to the to-be-decoded information. This is not limited.

S1106: The receiving device determines, based on the first information, the code length interval corresponding to the length of the information bit sequence, and determines the information column quantity corresponding to the code length interval as the target information column quantity.

The first information indicates the information column quantity corresponding to each of the plurality of code length intervals; the code length interval and the information column quantity corresponding to each code length interval are determined by comparing the A first metrics; the a^{th} first metric in the A first metrics is determined based on the b^{th} length value, the i^{th} information column quantity in the information column quantity set, and the j^{th} lifting size in the lifting size set, and the i^{th} information column quantity corresponds to the j^{th} lifting size; A is greater than or equal to 2; a=1, 2, . . . , A; the information column quantity set and the lifting size set are associated with the base graph corresponding to the length value; and the code length interval includes the B length values, and 1≤b≤B.

It may be understood that a method for determining, by the receiving device, the information column quantity corresponding to the code length interval is consistent with the foregoing method for determining, by the sending device, the information column quantity corresponding to the code length interval. Details are not described herein again.
S1107: The receiving device determines the target lifting size based on the target information column quantity and the length of the information bit sequence.

A method for determining the target lifting size by the receiving device is consistent with the foregoing method for determining the target lifting size by the sending device. Details are not described herein again.
S1108: The receiving device decodes the to-be-decoded information based on the target information column quantity and the target lifting size, to obtain a decoded information bit sequence.

Based on the sequence transmission method shown in FIG. 11, the sending device may explicitly determine, by determining the code length interval corresponding to the length of the information bit sequence, the information column quantity corresponding to the code length interval as the target information column quantity, thereby reducing computational complexity and improving work efficiency. The code length interval and the information column quantity corresponding to each code length interval are determined by comparing the A first metrics, so that a feasible solution is provided for determining the code length interval and the information column quantity corresponding to each code length interval. Therefore, the difference between the length value and the product of the target information column quantity and the target lifting size does not increase as the length of the bit sequence increases, and the difference may be relatively small or remain within a specific range. In this way, degree distribution of the base graph and integrity of the base graph can be protected, and decoding performance can be improved.

Based on the methods shown in FIG. 6 to FIG. 13, three possible simulations are performed in this application.

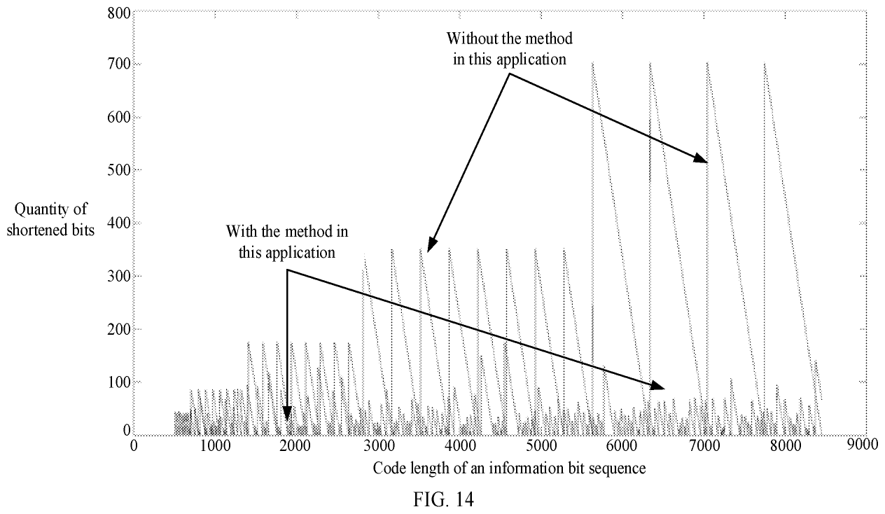

In a first possible simulation, as shown in FIG. 14, a horizontal axis represents a length of an information bit sequence, and a vertical axis represents a quantity of shortened bits. It can be learned that when the quantity of shortened bits is determined without using the method in this application, the quantity of shortened bits increases as the length of the information bit sequence increases. However, when the quantity of shortened bits is determined by using the method in this application, the quantity of shortened bits remains in a relatively stable interval over a variation range of the length of the information bit sequence, thereby ensuring integrity of a base graph and achieving more stable decoding performance.

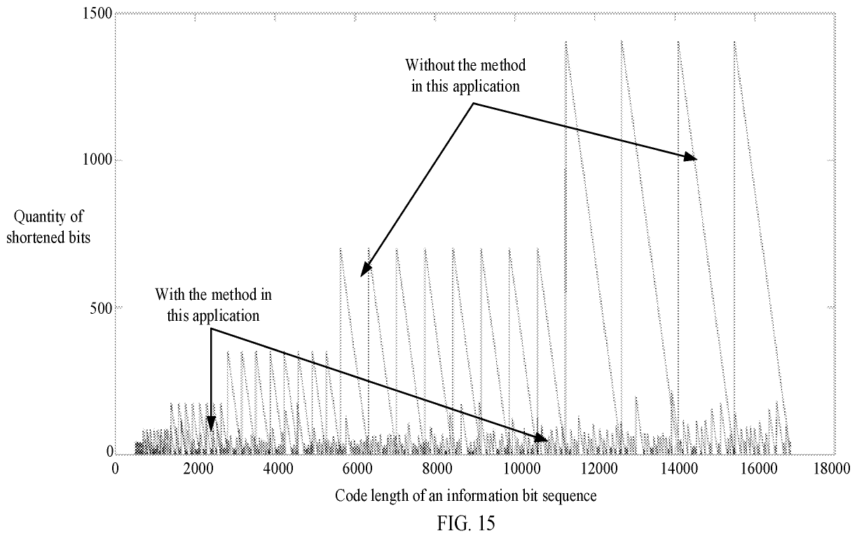

In a second possible simulation, as shown in FIG. 15, a horizontal axis represents a length of an information bit sequence, and a vertical axis represents a quantity of shortened bits. Compared with the first possible simulation, a range of the length of the information bit sequence in the simulation is extended. It can be learned that when the quantity of shortened bits is determined without using the method in this application, the quantity of shortened bits increases as the length of the information bit sequence increases. However, when the quantity of shortened bits is determined by using the method in this application, the quantity of shortened bits remains in a relatively stable interval over a variation range of the length of the information bit sequence, thereby ensuring integrity of a base graph and achieving more stable decoding performance.

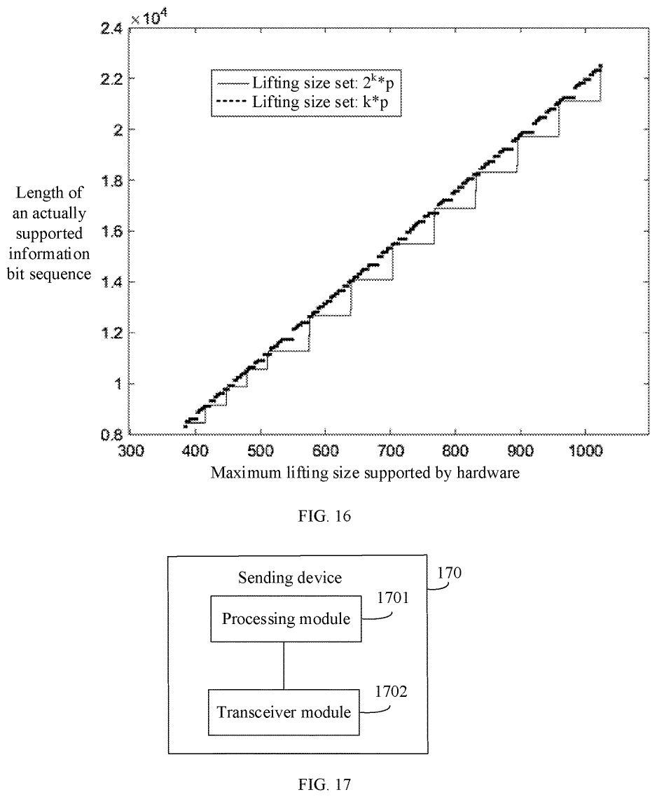

In a third possible simulation, as shown in FIG. 16, a horizontal axis represents a maximum lifting size supported by hardware, a vertical axis represents a length of an actually supported information bit sequence, a solid line represents a set of lifting sizes that are integer multiples of powers of 2, and a dashed line represents a set of lifting sizes that are linear multiples. It can be learned that when the set of lifting sizes are integer multiples of powers of 2, as the maximum lifting size supported by the hardware increases, parallelism and computing power supported by the hardware are improved, and a maximum length of an information bit sequence that can be actually supported increases in a stepwise manner. When the set of lifting sizes are linear multiples, as the maximum lifting size supported by the hardware increases, parallelism and computing power supported by the hardware are improved, and a maximum length of an information bit sequence that can be actually supported increases approximately linearly. Therefore, by using the method in this application, relatively high hardware utilization is achieved, and the sending device can use the computing power with a fine granularity.

It should be noted that embodiments of this application may be implemented separately, or may be implemented in combination. This is not limited. Unless otherwise stated or there is a logic conflict, terms and/or descriptions in different embodiments provided by this application are consistent and may be mutually referenced, and technical features in different embodiments may be combined into a new embodiment based on an internal logical relationship thereof.

It may be understood that an execution body may perform some or all of the steps in embodiments of this application. The steps or operations are merely examples. Embodiments of this application may further include performing other operations or variations of various operations. In addition, the steps may be performed in an order different from the order presented in embodiments of this application, and not all the operations in embodiments of this application may be performed.

The foregoing mainly describes the solutions provided in this application from the perspective of interaction between devices. Correspondingly, this application further provides a communication apparatus. The communication apparatus is configured to implement the foregoing methods. The communication apparatus may be the sending device in the foregoing method embodiments, or an apparatus including the sending device, or a component that may be used in the sending device; or the communication apparatus may be the sending device in the foregoing method embodiments, or an apparatus including the sending device, or a component that may be used in the sending device.

It may be understood that, to implement the foregoing functions, the communication apparatus includes a corresponding hardware structure and/or software module for performing each of the functions. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that the module division in embodiments of this application is an example, and is merely logical function division. There may be another division manner in actual implementation.

In an implementation scenario, an example in which the communication apparatus is the sending device in the foregoing method embodiments is used. FIG. 17 is a diagram of a structure of a sending device 170. The sending device 170 includes a processing module 1701 and a transceiver module 1702.

In some embodiments, the sending device 170 may further include a storage module (not shown in FIG. 17), configured to store program instructions and data.

In some embodiments, the transceiver module 1702 may also be referred to as a transceiver unit, and is configured to implement a sending function and/or a receiving function. The transceiver module 1702 may include a transceiver circuit, a transceiver machine, a transceiver, or a communication interface.

In some embodiments, the transceiver module 1702 may include a receiving module and a sending module that are respectively configured to perform the receiving and sending steps performed by the sending device in the foregoing method embodiments, and/or configured to support another process of the technology described in this specification. The processing module 1701 may be configured to perform the processing (for example, determining or generation) steps performed by the sending device in the foregoing method embodiments, and/or configured to support another process of the technology described in this specification.

For example, the processing module 1701 is configured to determine, based on an information bit sequence, an information column quantity set associated with a base graph corresponding to the information bit sequence and a lifting size set associated with the base graph; the processing module 1701 is further configured to determine a target information column quantity and a target lifting size based on the information column quantity set and the lifting size set, where the target information column quantity and the target lifting size are determined by comparing X first metrics, an x^{th} first metric in the X first metrics is determined based on a length of the information bit sequence, an i^{th} information column quantity in the information column quantity set, and a j^{th} lifting size in the lifting size set, and the i^{th} information column quantity corresponds to the j^{th} lifting size; X is greater than or equal to 2; and x=1, 2, . . . , X; and the processing module 1701 is further configured to perform encoding based on the target information column quantity and the target lifting size, to obtain an encoded bit sequence.

For another example, the processing module 1701 is configured to determine, based on first information, a code length interval corresponding to an information bit sequence, and determine an information column quantity corresponding to the code length interval as a target information column quantity, where the first information indicates an information column quantity corresponding to each of a plurality of code length intervals; the code length interval and the information column quantity corresponding to each code length interval are determined by comparing A first metrics; an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size; A is greater than or equal to 2; the information column quantity set and the lifting size set are associated with a base graph corresponding to the length value; a=1, 2, . . . , A; and the code length interval includes B length values, and 1≤b≤B; the processing module 1701 is further configured to determine a target lifting size based on the target information column quantity and a length of the information bit sequence; and the processing module 1701 is further configured to encode the information bit sequence based on the target information column quantity and the target lifting size, to obtain an encoded bit sequence.

In this application, the sending device 170 is presented in a form of functional modules obtained through integrated division. The “module” herein may be an ASIC, a circuit, a processor that executes one or more software or firmware programs, a memory, an integrated logic circuit, and/or another component that can provide the foregoing functions.

In some embodiments, in terms of hardware implementation, a person skilled in the art may figure out that the sending device 170 may be in a form of the communication apparatus 50 shown in FIG. 5.

In an example, the function or the implementation process of the processing module 1701 in FIG. 17 may be implemented by the processor 501 in the communication apparatus 50 shown in FIG. 5 by invoking the computer-executable instructions stored in the memory 503. The function or the implementation process of the transceiver module 1702 in FIG. 17 may be implemented by the communication interface 504 in the communication apparatus 50 shown in FIG. 5.

In some embodiments, when the sending device 170 in FIG. 17 is a chip or a chip system, the function or the implementation process of the transceiver module 1702 may be implemented by an input/output interface (or a communication interface) of the chip or the chip system, and the function or the implementation process of the processing module 1701 may be implemented by a processor (or a processing circuit) of the chip or the chip system.

The sending device 170 provided in this embodiment may perform the foregoing method. Therefore, for technical effects that can be achieved by the sending device 170, refer to the foregoing method embodiments. Details are not described herein again.

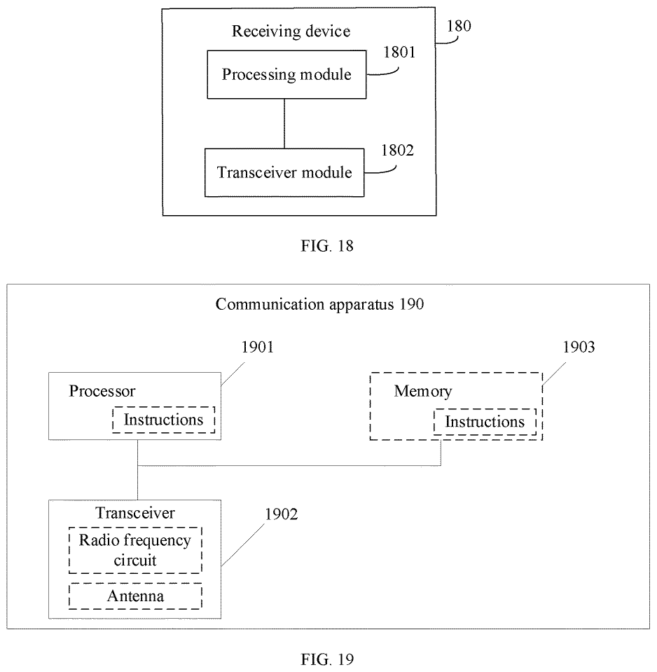

In another implementation scenario, an example in which the communication apparatus is the receiving device in the method embodiments is used. FIG. 18 is a diagram of a structure of a receiving device 180. The receiving device 180 includes a processing module 1801 and a transceiver module 1802.

In some embodiments, the receiving device 180 may further include a storage module (not shown in FIG. 18), configured to store program instructions and data.

In some embodiments, the transceiver module 1802 may also be referred to as a transceiver unit, and is configured to implement a sending function and/or a receiving function. The transceiver module 1802 may include a transceiver circuit, a transceiver machine, a transceiver, or a communication interface.

In some embodiments, the transceiver module 1802 may include a receiving module and a sending module that are respectively configured to perform the receiving and sending steps performed by the receiving device in the foregoing method embodiments, and/or configured to support another process of the technology described in this specification. The processing module 1801 may be configured to perform the processing (for example, determining or generation) steps performed by the receiving device in the foregoing method embodiments, and/or configured to support another process of the technology described in this specification.

For example, the transceiver module 1802 is configured to obtain to-be-decoded information from a sending device; and the processing module 1801 is configured to decode the to-be-decoded information based on a target information column quantity and a target lifting size, to obtain a decoded information bit sequence, where the target information column quantity and the target lifting size are determined by comparing X first metrics, an x^{th} first metric in the X first metrics is determined based on a length of the information bit sequence, an i^{th} information column quantity in an information column quantity set, and a j^{th} lifting size in a lifting size set, and the i^{th} information column quantity corresponds to the j^{th} lifting size; X is greater than or equal to 2; x=1, 2, . . . , X; and the information column quantity set and the lifting size set are associated with a base graph corresponding to the information bit sequence.

For another example, the transceiver module 1802 is configured to obtain to-be-decoded information from a sending device; the processing module 1801 is configured to determine a length of an information bit sequence corresponding to the to-be-decoded information; the processing module 1801 is further configured to determine, based on first information, a code length interval corresponding to the length of the information bit sequence, and determine an information column quantity corresponding to the code length interval as a target information column quantity, where the first information indicates an information column quantity corresponding to each of a plurality of code length intervals; the code length interval and the information column quantity corresponding to each code length interval are determined by comparing A first metrics; an a^{th} first metric in the A first metrics is determined based on a b^{th} length value, an i^{th} information column quantity in an information column quantity set, and a j^{th} lifting size in a lifting size set, and the i^{th} information column quantity corresponds to the j^{th} lifting size; A is greater than or equal to 2; a=1, 2, . . . , A; the information column quantity set and the lifting size set are associated with a base graph corresponding to the length value; and the code length interval includes B length values, and 1≤b≤B; the processing module 1801 is further configured to determine a target lifting size based on the target information column quantity and a length of the information bit sequence; and the processing module 1801 is further configured to decode the to-be-decoded information based on the target information column quantity and the target lifting size, to obtain a decoded information bit sequence.

In this application, the receiving device 180 is presented in a form of functional modules obtained through integrated division. The “module” herein may be an ASIC, a circuit, a processor that executes one or more software or firmware programs, a memory, an integrated logic circuit, and/or another component that can provide the foregoing functions.

In some embodiments, in terms of hardware implementation, a person skilled in the art may figure out that the receiving device 180 may be in a form of the communication apparatus 50 shown in FIG. 5.

In an example, the function or the implementation process of the processing module 1801 in FIG. 18 may be implemented by the processor 501 in the communication apparatus 50 shown in FIG. 5 by invoking the computer-executable instructions stored in the memory 503. The function or the implementation process of the transceiver module 1802 in FIG. 18 may be implemented by the communication interface 504 in the communication apparatus 50 shown in FIG. 5.

In some embodiments, when the receiving device 180 in FIG. 18 is a chip or a chip system, the function or the implementation process of the transceiver module 1802 may be implemented by an input/output interface (or a communication interface) of the chip or the chip system, and the function or the implementation process of the processing module 1801 may be implemented by a processor (or a processing circuit) of the chip or the chip system.

The receiving device 180 provided in this embodiment may perform the foregoing method. Therefore, for technical effects that can be achieved by the receiving device 180, refer to the foregoing method embodiments. Details are not described herein again.

In a possible product form, the sending device and the receiving device in embodiments of this application may alternatively be implemented by the following: one or more field-programmable gate arrays (FPGAs), a programmable logic device (PLD), a controller, a state machine, gate logic, a discrete hardware component, or any other appropriate circuit, or any combination of circuits capable of performing various functions described throughout this application.

In another possible product form, the sending device and the receiving device in embodiments of this application may be implemented by using a general bus architecture. For ease of description, FIG. 19 is a diagram of a structure of a communication apparatus 190 according to an embodiment of this application. The communication apparatus 190 includes a processor 1901 and a transceiver 1902. The communication apparatus 190 may be a sending device, or a chip or a module in the sending device; or the communication apparatus 190 may be a receiving device, or a chip or a module in the receiving device. FIG. 13 shows only main components of the communication apparatus 190. In addition to the processor 1901 and the transceiver 1902, the communication apparatus may further include a memory 1903.

Optionally, the processor 1901 is mainly configured to process a communication protocol and communication data, control the entire communication apparatus, execute a software program, and process data of the software program. The memory 1903 is mainly configured to store the software program and the data. The transceiver 1902 may include a radio frequency circuit and an antenna. The radio frequency circuit is mainly configured to perform conversion between a baseband signal and a radio frequency signal, and process the radio frequency signal. The antenna is mainly configured to receive and send a radio frequency signal in a form of an electromagnetic wave.

Optionally, the processor 1901, the transceiver 1902, and the memory 1903 may be connected through a communication bus.

After the communication apparatus is powered on, the processor 1901 may read the software program in the memory 1903, interpret and execute instructions of the software program, and process the data of the software program. When data needs to be sent in a wireless manner, the processor 1901 performs baseband processing on the to-be-sent data, and then outputs a baseband signal to the radio frequency circuit. The radio frequency circuit performs radio frequency processing on the baseband signal, and then sends a radio frequency signal in a form of an electromagnetic wave through the antenna. When data is sent to the communication apparatus, the radio frequency circuit receives a radio frequency signal through the antenna, converts the radio frequency signal into a baseband signal, and outputs the baseband signal to the processor 1901. The processor 1901 converts the baseband signal into data and processes the data.

In another implementation, the radio frequency circuit and the antenna may be disposed independent of the processor that performs baseband processing. For example, in a distributed scenario, the radio frequency circuit and the antenna may be disposed remotely and independent of the communication apparatus.

In some embodiments, an embodiment of this application further provides a communication apparatus. The communication apparatus includes a processor, configured to implement the method in any one of the foregoing method embodiments. The communication apparatus may be the sending device or the receiving device in the foregoing method embodiments.

In a possible implementation, the communication apparatus further includes a memory. The memory is configured to store a necessary computer program and data. The computer program may include instructions. The processor may invoke the instructions in the computer program stored in the memory, to instruct the communication apparatus to perform the method in any one of the foregoing method embodiments. Certainly, the communication apparatus may not include a memory.

In another possible implementation, the communication apparatus further includes an interface circuit. The interface circuit is a code/data read/write interface circuit, and the interface circuit is configured to receive computer-executable instructions (the computer-executable instructions are stored in a memory, and may be directly read from the memory, or may be read via another component) and send the computer-executable instructions to the processor.

In still another possible implementation, the communication apparatus further includes a communication interface, and the communication interface is configured to communicate with a module outside the communication apparatus.

It may be understood that the communication apparatus may be a chip or a chip system. When the communication apparatus is the chip system, the communication apparatus may include a chip, or may include a chip and another discrete component. This is not specifically limited in embodiments of this application.

This application further provides a computer-readable storage medium. The computer-readable storage medium stores a computer program or instructions. When the computer program or the instructions are executed by a computer, functions of any foregoing method embodiment are implemented.

This application further provides a computer program product. When the computer program product is executed by a computer, functions of any one of the foregoing method embodiments are implemented.

A person of ordinary skill in the art may understand that, for the purpose of convenient and brief description, for a detailed working process of the foregoing system, apparatuses, and units, refer to a corresponding process in the foregoing method embodiments. Details are not described herein again.

It may be understood that the system, apparatuses, and methods described in this application may alternatively be implemented in another manner. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may be physically separated or not, this is, may be located together in the same place or distributed on a plurality of network units. Parts displayed as units may be or may be not physical units. Some or all of the units may be selected based on actual requirements to achieve the objectives of the solutions in embodiments.

In addition, functional units in embodiments of this application may be integrated into one processing unit, each of the units may exist alone physically, or two or more units are integrated into one unit.

All or some of the foregoing embodiments may be implemented by software, hardware, firmware, or any combination thereof. When a software program is used to implement embodiments, embodiments may be implemented completely or partially in a form of a computer program product. The computer program product includes one or more computer instructions. When the computer program instructions are loaded and executed on a computer, all or some of procedures (or functions) described in embodiments of this application are implemented. The computer may be a general-purpose computer, a dedicated computer, a computer network, or another programmable apparatus. The computer instructions may be stored in the computer-readable storage medium or may be transmitted from the computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or may be a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like. In embodiments of this application, the computer may include the foregoing apparatuses.

Although this application is described with reference to embodiments, in a process of implementing this application that claims protection, a person skilled in the art may understand and implement another variation of the disclosed embodiments by viewing the accompanying drawings, disclosed content, and the appended claims. In the claims, “comprising” does not exclude another component or another step, and “a” or “one” does not exclude a case of “a plurality”. A single processor or another unit may implement several functions enumerated in the claims. Some measures are described in dependent claims that are different from each other, but this does not mean that these measures cannot be combined to produce better effect.

1. A method comprising:
determining an information column quantity set associated with a base graph corresponding to th information bit sequence and a lifting size set associated with the base graph;
determining a target information column quantity and a target lifting size based on the information column quantity set and the lifting size set by comparing X first metrics, wherein an x^{th} first metric in the X first metrics is based on a length of the information bit sequence, an i^{th} information column quantity in the information column quantity set, and a j^{th} lifting size in the lifting size set, wherein the i^{th} information column quantity corresponds to the j^{th} lifting size, wherein X is greater than or equal to 2, and wherein x=1, 2, . . . , X; and
encoding the information bit sequence based on the target information column quantity and the target lifting size to obtain an encoded bit sequence.

2. The method of claim 1, wherein the x^{th} first metric comprises either a difference between a first product and the length of the information bit sequence or a ratio of the difference to the j^{th} lifting size, and wherein the first product comprises a product of the i^{th} information column quantity and the j^{th} lifting size.

3. The method of claim 1, wherein:
the j^{th} lifting size is a smallest lifting size that is in the lifting size set and that supports the i^{th} information column quantity in meeting a first condition, wherein the first condition comprises a product of the i^{th} information column quantity and a lifting size in the lifting size set is greater than or equal to the length of the information bit sequence;
the j^{th} lifting size is a smallest lifting size that is in the lifting size set and has a first value equal to
$${n}^{⌈ {log}_{n} ( \frac{K}{{K}_{i} q} ) ⌉} q .$$
wherein n is an integer greater than or equal to 2, wherein K is the length of the information bit sequence, wherein Kᵢ is the i^{th} information column quantity in the information column quantity set, and wherein g is a positive integer; or
the j^{th} lifting size is a smallest lifting size that is in the lifting size set and with has a second value equal to
$$⌈ \frac{K}{{K}_{i} q} ⌉ q .$$

4. The method of claim 3, wherein when q is a prime number, the j^{th} lifting size is is bas the second value equal to
$$⌈ \frac{K}{{K}_{i} q} ⌉ q .$$

5. The method of claim 1, wherein the i^{th} information column quantity comprises:
a smallest information column quantity that is in the information column quantity set and that supports the j^{th} lifting size in meeting a second condition, wherein the second condition comprises a product of the j^{th} lifting size and a first information column quantity in the information column quantity set is greater than or equal to the length of the information bit sequence; or
the second information column quantity that is in the information column quantity set and whose value is equal to
$$\frac{K}{{Z}_{j}} .$$

6. The method of claim 1, wherein the information column quantity set comprises I information column quantities, wherein 1≤i≤I, wherein the lifting size set comprises J lifting sizes, and wherein 1≤j≤J.

7. The method of claim 1, wherein determining the target information column quantity and the target lifting size comprises:
determining the target information column quantity and the target lifting size based on a smallest value of the X first metrics; or
determining Y first metrics based on the X first metrics, determining the target information column quantity and the target lifting size based on the Y first metrics,
wherein a y^{th} first metric in the Y first metrics is less than or equal to a first threshold corresponding to the y^{th} first metric,
wherein Y is greater than or equal to 1, and
wherein y=1, 2, . . . , Y.

8. The method of claim 1, further comprising determining a first threshold corresponding to the x^{th} first metric is based on a lifting size corresponding to the x^{th} first metric.

9. The method of claim 8, wherein the first threshold comprises:
Zc, 2Zc, 3/2Zc, ½Zc, ⅓Zc, or ¼Zc, wherein Zc is the lifting size; or
1, 2, 3/2, ½, ⅓, or ¼.

10. The method of claim 9, wherein determining the target information column quantity and the target lifting size comprises:
determining, when there are at least two smallest values, a largest or smallest one of at least two information column quantities corresponding to the at least two smallest values as the target information column quantity, and a lifting size corresponding to the target information column quantity as the target lifting size;
determining, when there are at least two smallest values, a largest or smallest one of at least two lifting sizes corresponding to the at least two smallest values is determined as the target lifting size, and an information column quantity corresponding to the target lifting size as the target information column quantity;
determining, when there are at least two smallest values, the target information column quantity from at least two information column quantities corresponding to the at least two smallest values based on indication information, and a lifting size corresponding to the target information column quantity as the target lifting size, wherein the indication information indicates a communication scenario; or
determining when there are at least two smallest values, the target lifting size from at least two lifting sizes corresponding to the at least two smallest values based on metric information, and an information column quantity corresponding to the target lifting size as the target information column quantity.

11. The method of claim 9, wherein determining that the target information column quantity and the target lifting size comprises:
determining, when Y is greater than 1, a largest or smallest one of Y information column quantities corresponding to the Y first metrics as the target information column quantity, and a lifting size corresponding to the target information column quantity as the target lifting size;
determining, when Y is greater than 1, a largest or smallest lifting size of Y information column quantities corresponding to the Y first metrics as the target lifting size, and an information column quantity corresponding to the target lifting size as the target information column quantity;
determining when Y is greater than 1, the target information column quantity from Y information column quantities corresponding to the Y first metrics based on first indication information, and a lifting size corresponding to the target information column quantity as the target lifting size, wherein the first indication information indicates a communication scenario; or
determining, when Y is greater than 1, the target lifting size from Y lifting sizes corresponding to the Y first metrics based on the first indication information, and an information column quantity corresponding to the target lifting size as the target information column quantity.

12. A method comprising:
determining, based on first information, a first code length interval corresponding to an information bit sequence by comparing A first metrics;
determining a first information column quantity corresponding to the first code length interval as a target information column quantity by comparing the A first metrics, wherein the first information indicates a correspondence between the first information column quantity and the first code length interval, wherein an a^{th} first metric in the A first metrics is based on a b^{th} length value, an i^{th} information column quantity in an information column quantity set, and a j^{th} lifting size in a lifting size set, wherein the i^{th} information column quantity corresponds to the j^{th} lifting size; wherein A is greater than or equal to 2, wherein the first information column quantity set and the lifting size set are associated with a base graph corresponding to a length value, wherein a=1, 2, . . . , A, wherein the first code length interval comprises B length values, and wherein 1≤b≤B;
determining a target lifting size based on the target information column quantity and a length of the information bit sequence; and
encoding the information bit sequence based on the target information column quantity and the target lifting size, size to obtain an encoded bit sequence.

13. The method of claim 12, wherein the a^{th} first metric comprises either a difference between a first product and the b^{th} length value or a ratio of the first product to the j^{th} lifting size, and wherein the first product comprises a product of the i^{th} information column quantity and the j^{th} lifting size.

14. The method of claim 12, further comprising:
further determining the first code length interval based on a second information column quantity corresponding to the length value; and
further determining the first information column quantity based on the second information column quantity.

15. The method of claim 12, wherein determining the target lifting size comprises determining a lifting size corresponding to the target information column quantity as the target lifting size.

16. The method of claim 12, wherein the first information indicates:
a second information column quantity corresponding to a second code length interval (500, 570) is 24, a third information column quantity corresponding to a third code length interval (571, 600) is 26, and a fourth information column quantity corresponding to a fourth code length interval is 22, wherein the fourth code length interval is less than the second first-code length interval and greater than the third code length interval;
a fifth information column quantity corresponding to fifth code length intervals (500, 570) and (700, 770) is 24, a sixth information column quantity corresponding to sixth code length intervals (571, 600) and (771, 800) is 26, and a seventh information column quantity corresponding to a seventh code length interval is 22; or
an eighth information column quantity corresponding to eighth code length intervals (703, 728) and (781, 832) is 8, a ninth information column quantity corresponding to ninth code length intervals (625, 650) and (875, 910) is 10, and a tenth information column quantity corresponding to a tenth code length interval is 6.

17. The method of claim 12, further comprising determining, based on the target information column quantity and an indication sequence, target information columns from the base graph corresponding to the information bit sequence, wherein the indication sequence indicates positions of information columns in the base graph.

18. The method of claim 17, wherein a length of the indication sequence is a maximum information column quantity corresponding to the base graph.

19. The method of claim 17, wherein elements of the indication sequence correspond to columns of the base graph.

20. A communication apparatus, comprising:
a memory configured to store instructions; and
one or more processors coupled to the memory and configured to execute the instructions to cause the communication apparatus to:
determine, an information column quantity set associated with a base graph corresponding to an information bit sequence and a lifting size set associated with the base graph;
determine a target information column quantity and a target lifting size based on the information column quantity set and the lifting size set, wherein the target information column quantity and the target lifting size based on a comparison of X first metrics, wherein an x^{th} first metric in the X first metrics is based on a length of the information bit sequence, an i^{th} information column quantity in the information column quantity set, and a j^{th} lifting size in the lifting size set, wherein the i^{th} information column quantity corresponds to the j^{th} lifting size, wherein X is greater than or equal to 2, and wherein x=1, 2, . . . , X; and
encode the information bit sequence based on the target information column quantity and the target lifting size to obtain an encoded bit sequence.
